(19) United States
(12) Patent Application Publication
(10) Pub. No.: US 2023/0249174 A1
(43) Pub. Date: Aug. 10, 2023

(54) METHODS TO CONSTRUCT SHARP AND STABLE TIP CONTACTS WITH NANOMETER PRECISION IN A CONFINED NANOSCALE SPACE BETWEEN TWO MICROFLUIDIC CHAMBERS

(71) Applicant: ARIZONA BOARD OF REGENTS ON BEHALF OF ARIZONA STATE UNIVERSITY, SCOTTSDALE, AZ (US)

(72) Inventor: Quan Qing, Chandler, AZ (US)

(21) Appl. No.: 18/004,663

(22) PCT Filed: Jul. 6, 2021
(86) PCT No.: PCT/US2021/040562

§ 371 Date: Jan. 6, 2023

Related U.S. Application Data
(60) Provisional application No. 63/049,481, filed on Jul. 8, 2020.
(60) Provisional application No. 63/107,687, filed on Oct. 30, 2020.

(51) Int. Cl. B01L 3/00; G01N 21/65

(52) U.S. Cl. CPC B01L 3/5027; G01N 21/658; B01L 2300/0645; B01L 2300/0861; B01L 2300/16

(57) ABSTRACT

Disclosed are systems and methods for delivering and/or linking molecules, such as DNA, between tunable metal nanogaps and measuring electrical and/or optical properties.

### GOVERNMENT SUPPORT CLAUSE

This invention was made with government support under FA9550-16-1-0052 awarded by the Air Force Office of Scientific Research. The government has certain rights in the invention.

### FIELD

This disclosure relates to single molecule detection and in particular, to systems and methods for delivering and/or linking molecules between tunable metal nanogaps and measuring electrical and optical properties.

### BACKGROUND

The electrical conductance and optical property such as Raman spectrum from a single molecule can reveal critical information of its structure and conformation. The time-dependent recording of the molecular conductance and Raman spectrum of biological molecules, such as DNA, RNA and protein, under physiological configurations, could be correlated to its specific sequence as well as dynamic conformations/functions.

However, to put a single molecule between a pair of metal and reliably evaluate its conductance and optical properties is not an easy task. There has been a lot of efforts on evaluating electrical properties of single-molecule using scanning tunneling microscope (STM) techniques where a metal tip (typically made of gold) is used to first get in contact with and then pull back from a metal substrate (typically gold) repetitively in an environment (typically in solution) of target molecules around the tip, so that when accidentally a molecule bumps into the gap formed under the tip as it pulls away from the substrate, the current-voltage (I-V) curve can be captured showing characteristics different from those of the “blank” pulls. There are also methods based on break-junctions where a suspended thin and small metal bar on a substrate is pulled broken apart by mechanical bending the substrate to create a fresh junction for molecules to fill in. With all these methods, the molecules cannot be controllably mounted and every junction as it forms is never predictable or reproducible. There is also no easy optical access to the molecule in all of these methods. Therefore, the information of the molecules is usually extracted from statistical analysis of many repeated trials, where useful signals are only embedded in heavy noise background. In addition, these evaluations cannot be performed in a physiological environment, so it is not possible to capture the dynamics of a functioning molecule. Therefore, a new system and method to reliably mount a single molecule between a pair of metal electrodes and to allow both electrical and optical characterization of the structure and dynamics of the molecule is needed.

### SUMMARY

Disclosed herein is a new system and method of measuring the electrical and optical properties of single molecules using a tunable metal nanogaps embedded in a nanofluidic system. Different analytes can be guided in the nanofluidic system through several stages of channels to a confined space where the metal nanogap is formed by feedback controlled electrochemical process with a size comparable to the length or diameter of the molecule. In some examples, the molecule may be able to mount to the surfaces of one or more tips of the nanogap electrodes through chemical bonds or electrostatic interactions to form a stable junction. I-V characterization and optical detection such as tip-enhanced Raman spectrum of the molecule may be collected to study the structure and functions of the molecules in physiological environment. The event of the mounting can be simultaneously detected by the ionic current changes inside the nanofluidic chambers, and the tunneling current across the metal nanogap, therefore providing a solid foundation for unambiguous analysis of background-free signals.

In embodiments, an electronic device comprises a cis-fluidic channel/chamber and a trans-fluidic channel/chamber fabricated on a planar substrate; a nanogap configured in between and connecting the cis-fluidic and trans-fluidic channels/chambers; a first electrode and a second electrode sealed inside the channel, wherein the first and second electrodes being electrochemically deposited with one or more metal materials within the channel and under feed-back control, thereby forming an electronic device with a single path for a molecule to travel from the cis-fluidic channel/chamber to the trans-fluidic channel/chamber and the distance between the first and second electrodes being between about 1-100 nm to form the nanogap which is self-aligned and has a narrowest bottleneck in the path between the cis-fluidic and trans-fluidic channels/chambers.

In embodiments, the planar substrate is a transparent substrate, such as glass or quartz.

In embodiments, the planar substrate is a non-transparent substrate, such as silicon coated with a layer of oxide.

In embodiments, the first electrode and second electrode are formed of gold, palladium, platinum or combinations thereof.

In embodiments, the cavity in which the first electrode and second electrode are sealed is formed by one or more dielectric layers.

In embodiments, the one or more dielectric layers is comprised of HfO2, SiO2, SU8 or any combination thereof.

In embodiments, one or more metals are Ni, Co, Ni alloy, Co alloy, gold palladium, platinum, iridium or their alloys or combinations thereof.

In embodiments, the first and second electrodes being electrochemically deposited with one or more metal materials within the channel and under feed-back control comprises a pulsed electrochemical deposition operation with a pulse width of 50 ms or less and a rest period of about 2 seconds between pulses.

In embodiments, the molecule is DNA.

In embodiments, a method to measure conductance and/or optical properties from single molecules comprises detecting with a disclosed device an individual mounting and/or translocation event of single molecules by a correlated ionic current between channels/chambers and tunneling current between the first and second electrodes through the nanogap; and performing electrical and optical characterization.

In embodiments, performing optical characterization includes performing Raman spectroscopy, such as by performing tip-enhanced Raman spectrum through the transparent substrate to understand dynamic structure of single molecules.

In embodiments, performing optical characterization includes focusing an objective lens of a microscope on the nanogap through the transparent substrate, to track the motion and translocation of the single molecules via fluorescent signals.

In embodiments, a method of making a device for delivering and/or linking molecules between tunable metal nanogaps and measuring electrical and/or optical properties allowing for single molecule detection, comprises depositing one or more sacrificial layers on a planar substrate to define a guiding channel leading to a tunneling junction and height of a confined space for allowing electrochemical deposition; positioning a pair of electrodes with spacing around 500 nm and 1 μm on top of a center region of the one or more sacrificial layers; depositing a dielectric passivation layer on the pair of electrodes to seal the pair of electrodes within the one or more sacrificial layers; depositing a top polymer of dielectric layer patterned to construct the shape of channels on top of the dielectric passivation layer to both protect the pair of electrodes underneath and serve as a mask; exposing the one or more sacrificial layers below an open window area in the polymer or di-electric top mask by a reactive ion etching process; attaching a top cover to seal the channels; chemically etching one or more sacrificial layers by filling the channels with etchants for construct of the chambers/channels that lead to the pair of electrodes; and depositing an additional metal layer onto each of the electrodes by electrochemical deposition, thereby forming the device for delivering and linking molecules between tunable metal nanogaps and measuring electrical and optical properties allowing for single molecule detection.

In embodiments, the planar substrate is a transparent substrate, such as glass or quartz.

In embodiments, the planar substrate is a non-transparent substrate such as silicon coated with a layer of oxide.

In embodiments, the pair of electrodes are formed of gold, palladium, platinum or combinations thereof.

In embodiments, the dielectric passivation layer on the pair of electrodes to seal the pair of electrodes within the one or more sacrificial layers is HfO2, SiO2, SU8 or any combination thereof.

In embodiments, the additional metal is Ni, Co, Ni alloy, Co alloy, gold, palladium, platinum, iridium or their alloys or combinations thereof.

In embodiments, the top polymer layer is patterned to construct the shape of channels on top of the dielectric passivation layer to both protect the pair of electrodes underneath and serve as a mask is SU-8.

In embodiments, the top dielectric layer patterned to construct the shape of channels on top of the dielectric passivation layer to both protect the pair of electrodes underneath and serve as a mask is SiO2.

In embodiments, the method produces electrodes that are 5-200 nm thick in a planar configuration.

In embodiments, single molecule detection is detection of single DNA molecule.

In embodiments, depositing the additional metal layer onto each of the electrodes by electrochemical deposition is via a pulsed electrochemical deposition operation comprising a pulse width of 50 ms or less and a rest period of about 2 seconds between pulses.

In embodiments the pulse width is between 2-5 ms. In some embodiments, the pulse width is less than 2 ms but greater than 1 μs.

In another embodiment, a method of making a nanopore device that includes a nanopore and a tunneling junction, comprises depositing a first sacrificial layer defining a final cavity for electrochemical deposition and depositing a second outer sacrificial layer defining a final nanofluidic space connecting the nanopore to cis- and trans-chambers onto a substrate layer; positioning a pair of electrodes with a spacing of about 500 nm to 1 μm on top of the first sacrificial layer; depositing a passivation layer on top of the pair of electrodes, the first sacrificial layer, the second sacrificial layer and the planar substrate to seal the pair of electrodes and the first and second sacrificial layers; conducting a dry etching process to remove one or more sections of the passivation layer to produce access windows to the second sacrificial layer; attaching a top cover atop the passivation layer remaining following the dry etching process; chemically etching the first and second sacrificial layers to construct the final cavity and the final nanofluidic space; and narrowing the spacing between the pair of electrodes by a process of controlled electrodeposition of a metal onto the pair of electrodes to form the nanopore and the tunneling junction.

In embodiments, the process of controlled electrodeposition further comprises conducting a pulsed electrochemical deposition operation comprising a pulse width of 50 ms or less and a rest period of between about 500 ms and 2 seconds between pulses. In some examples the pulse width is between 1 ms and 5 ms. In some examples, the pulse width is between 1 μs and 500 μs.

In embodiments, narrowing the spacing between the pair of electrodes by the process of controlled electrodeposition further comprises establishing a bias of about 50-100 mV between the cis- and trans-chambers.

In embodiments, narrowing the spacing between the pair of electrodes by the process of controlled electrodeposition further comprises providing the metal in both the cis- and trans-chambers.

In embodiments, narrowing the spacing between the pair of electrodes by the process of controlled electrodeposition further comprises providing the metal in just one of the cis- and trans-chambers.

In embodiments, narrowing the spacing between the pair of electrodes by the process of controlled electrodeposition further comprises repeatedly narrowing and then expanding the spacing between the pair of electrodes any number of time via repetitive reversing of the polarity of the potential pulses applied to the electrodes.

In embodiments, narrowing the spacing between the pair of electrodes by the process of controlled electrodeposition is used to create a final spacing between the pair of electrodes of 1 nm to 100 nm. In example, the final spacing is 1 nm to 20 nm. In other examples, the final spacing is 1-2 nm.

The foregoing and other features of the disclosure will become more apparent from the following detailed description, which proceeds with reference to the accompanying figures.

### BRIEF DESCRIPTION OF DRAWINGS

Embodiments will be readily understood by the following detailed description in conjunction with the accompanying drawings and the appended claims. Embodiments are illustrated by way of example and not by way of limitation in the figures of the accompanying drawings.

FIGS. 1A-1D show approximately 100% correlated signals from both the ionic current channel and the tunneling current channel identifies the same DNA translocation events. FIGS. 1A and 1B show long time record of translocation happening in both directions as depicted in both polarities of the signals. FIG. 1C is a single event showing the time and polarity correlation between the tunneling current and the ionic current. FIG. 1D shows schematics of how the signals in FIGS. 1A-1C were recorded using the device. It shows the top view of the device with cis- and trans-channels between which molecules are driven through a pair of metal electrodes forming the nanogap.

FIG. 2 shows schematics illustrating various stages of fabrication of a disclosed device in accordance with embodiments disclosed herein.

FIGS. 3A and 3B show schematics of detection of molecule conductance and optical properties in a prepared device fabricated on transparent substrate in accordance with embodiments disclosed herein.

FIGS. 4A-4B show schematics of preparing nanopore devices with self-aligned transverse tunneling junction and molecular analyte translocation detection.

FIG. 5A depicts (left) an image of an assembled nanopore chip mounted on a customized printed circuit board with optical access to devices, (middle) an image of the nanopore chip on a tissue paper based on a 1 inch×1 inch quartz cover slip, and (right) a magnified image of one initial nanopore device.

FIG. 5B depicts a plurality of schematics illustrating fabrication steps of the nanopore device including construction of the initial device and the final preparation, according to an embodiment.

FIG. 5C depicts 3D models of the nanopore device before etching (left) and after preparation for recording (right).

FIGS. 6A-6E depict a design of a planar gated nanopore device chip of the present disclosure. FIG. 6A shows a schematic of the microfluidic channels. FIG. 6B is a schematic of the structure of guidance channels before wet etch. FIG. 6C is a schematic of the initial gap of electrode tips before wet etch. FIGS. 6D-6E depict images of fabricated device chips before PDMS sealing (top, FIG. 6D and tilted, FIG. 6E).

FIGS. 7A-7B show graphs of current-voltage (IV) scans between two fluidic chambers (e.g., cis and trans) at different stages of gap preparation.

FIGS. 8A-8C illustrate the electric potential profile of planar-gated nanopore devices of the present disclosure.

FIGS. 9A-9E illustrate how reversible pulsed electrochemical deposition can be used to precisely control nanopore and tunneling junction dimensions.

FIGS. 10A-10B depict selected frames of time lapse recordings during electrode metal depositions with different deposition pulses.

FIGS. 10C-10D illustratively depicts options for influencing/optimizing nanopore geometry during the process of electrodeposition of metal onto tunneling junction electrodes.

FIGS. 11A-11C show DNA translocation events detected simultaneously from ionic current and from current between transverse electrodes for a nanopore device of the present disclosure.

FIG. 12 is a graph showing detection of DNA translocation in correlated tunneling and ionic current as a function of various driving bias and gap bias.

FIG. 13 is a graph depicting a section of bi-directional translocation events for the nanopore devices of the present disclosure.

FIGS. 14A-14E are graphs showing characteristics of signals corresponding to forward and backward translocation events for nanopore devices of the present disclosure.

### DETAILED DESCRIPTION OF DISCLOSED EMBODIMENTS

In the following detailed description, reference is made to the accompanying drawings that form a part hereof, and in which are shown by way of illustration embodiments that may be practiced. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments; however, the order of description should not be construed to imply that these operations are order dependent.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the terms “embodiment” or “embodiments,” which may each refer to one or more of the same or different embodiments. Furthermore, the terms “comprising,” “including,” “having,” and the like, as used with respect to embodiments, are synonymous, and are generally intended as “open” terms (e.g., the term “including” should be interpreted as “including but not limited to,” the term “having” should be interpreted as “having at least,” the term “includes” should be interpreted as “includes but is not limited to,” etc.).

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity.

The term “a” or “an” may mean more than one of an item.

The term “about” means within plus or minus 10% of a stated value. For example, “about 100” would refer to any number between 90 and 110.

Unless otherwise noted, technical terms are used according to conventional usage. Suitable methods and materials for the practice or testing of this disclosure are described below. Such methods and materials are illustrative only and are not intended to be limiting. Other methods and materials similar or equivalent to those described herein can be used. For example, conventional methods well known in the art to which this disclosure pertains are described in various general references.

### I. Terms

To facilitate review of the various embodiments of the disclosure, the following explanations of specific terms are provided:

Analyte: A substance whose chemical constituents are being identified and measured. In some examples, an analyte includes DNA, proteins, enzymes, and/or other bio-molecules which have an extremely small volume.

Binding or stable binding: An association between two substances or molecules, such as the association of an antibody with a peptide. Binding can be detected by any procedure known to one skilled in the art, such as by physical or functional properties of the formed complexes.

Biomolecule: A molecule that is produced by a living organism. For example, a biomolecule is an organic molecule and especially a macromolecule (such as a protein or nucleic acid) in living organisms. In some examples, biomolecule is interchangeable with “analyte molecule.”

Chemical Modification: A number of various processes involving the alteration of the chemical constitution or structure of molecules. In one example, a chemically-modified electrode is an electrode that has a surface chemically converted to change the electrode's properties, such as its' physical, chemical, electrochemical, optical, electrical, and/or transport characteristics.

Cis-chamber and Trans-chamber: A “cis-chamber” is first chamber and a “trans-chamber” is a second chamber that is opposite to the cis-chamber, such as on an opposite side of cis-chamber. In embodiments, the cis chamber is a chamber with a negative electrode and the trans-chamber on the opposite side of a nanogap is the chamber with a positive electrode such that a negatively charged molecule in the cis-chamber can be guided through the nanogap to trans-chamber by a driving bias.

Contacting: Placement in direct physical association, including both a solid and liquid form.

Current stream: The term “current stream” refers to the current signal generated over time from a device described herein.

Deposit: An accumulation or layer of solid material, either consolidated or unconsolidated, left or laid down.

Dielectric: A dielectric material is a type of insulator which becomes polarized when it comes in contact with an electrical field. When dielectrics are placed in an electric field, practically no current flows in them because, unlike metals, they have no loosely bound, or free, electrons that may drift through the material. Instead, electric polarization occurs.

Electrochemical Deposition: A process by which a thin and tightly adherent desired coating of metal, oxide, or salt can be deposited onto the surface of a conductor substrate by simple electrolysis of a solution containing the desired metal ion or its chemical complex. Electrochemical deposition transports metal ions in a solution by an electric field to coat the surface of a substrate. Electrochemical deposition is an efficient procedure to prepare metal nanoparticles.

Isolated: An “isolated” biological component (such as a nucleic acid molecule, protein, or cell) has been substantially separated or purified away from other biological components in the cell of the organism, or the organism itself, in which the component naturally occurs, such as other chromosomal and extra-chromosomal DNA and RNA, proteins and cells. Nucleic acid molecules and proteins that have been “isolated” may be understood to have been purified by standard purification methods. The term also embraces nucleic acid molecules and proteins prepared by recombinant expression in a host cell as well as chemically synthesized nucleic acid molecules and proteins.

Label: An agent capable of detection, for example, a label can be attached to a nucleic acid molecule or protein (indirectly or directly), thereby permitting detection of the nucleic acid molecule or protein. Examples of labels include, but are not limited to, radioactive isotopes, enzyme substrates, co-factors, ligands, chemiluminescent agents, fluorophores, haptens, enzymes, and combinations thereof. Methods for labeling and guidance in the choice of labels appropriate for various purposes are discussed for example in Sambrook et al. (Molecular Cloning: A Laboratory Manual, Cold Spring Harbor, New York, 1989) and Ausubel et al. (In Current Protocols in Molecular Biology, John Wiley & Sons, New York, 1998).

Linked or linker: The term “linked” means joined together, either directly or indirectly. For example, a first moiety may be covalently or noncovalently (e.g., electrostatically) linked to a second moiety. This includes, but is not limited to, covalently bonding one molecule to another molecule, noncovalently bonding one molecule to another (e.g., electrostatically bonding), non-covalently bonding one molecule to another molecule by hydrogen bonding, non-covalently bonding one molecule to another molecule by van der Waals forces, and any and all combinations of such couplings. Indirect attachment is possible, such as by using a “linker” (a molecule or group of atoms positioned between two moieties).

In several embodiments, linked components are associated in a chemical or physical manner so that the components are not freely dispersible from one another. For example, two components may be covalently bound to one another so that the two components are incapable of separately dispersing or diffusing.

Nucleic acid: A deoxyribonucleotide or ribonucleotide polymer, which can include analogues of natural nucleotides that hybridize to nucleic acid molecules in a manner similar to naturally occurring nucleotides. In a particular example, a nucleic acid molecule is a single stranded (ss) DNA or RNA molecule, such as a probe or primer. In another particular example, a nucleic acid molecule is a double stranded (ds) nucleic acid, such as a target nucleic acid. The term “nucleotide” refers to a base-sugar-phosphate combination and includes ribonucleoside triphosphates ATP, UTP, CTG, GTP and deoxyribonucleoside triphosphates such as dATP, dCTP, dITP, dUTP, dGTP, dTTP, or derivatives thereof.

Optional: “Optional” or “optionally” means that the subsequently described event or circumstance can but need not occur, and that the description includes instances where said event or circumstance occurs and instances where it does not.

Protein: The terms “protein,” “peptide,” “polypeptide” refer, interchangeably, to a polymer of amino acids and/or amino acid analogs that are joined by peptide bonds or peptide bond mimetics. The twenty naturally-occurring amino acids and their single-letter and three-letter designations are as follows: Alanine A Ala; Cysteine C Cys; Aspartic Acid D Asp; Glutamic acid E Glu; Phenylalanine F Phe; Glycine G Gly; Histidine H His; Isoleucine I He; Lysine K Lys; Leucine L Leu; Methionine M Met; Asparagine N Asn; Proline P Pro; Glutamine Q Gln; Arginine R Arg; Serine S Ser; Threonine T Thr; Valine V Val; Tryptophan w Trp; and Tyrosine Y Tyr. In one embodiment, a peptide is an antibody or fragment or part thereof, for example, any of the fragments or antibody chains listed above. In some embodiments, the peptide may be post-translationally modified.

Raman Spectroscopy: A spectroscopic technique typically used to determine vibrational modes of molecules, although rotational and other low-frequency modes of systems may also be observed. Raman spectroscopy can be used in chemistry to provide a structural fingerprint by which molecules can be identified.

Sample: A mixture of molecules that comprises at least an analyte molecule that is subjected to manipulation in accordance with the systems and/or methods of the disclosure.

Translocation: A change in location. As used herein, a DNA translocation event, refers to DNA moving through a nanogap.

Transparent substrate: A material made up of components with a uniform index of refraction. Transparent materials appear clear, with the overall appearance of one color, or any combination leading up to a brilliant spectrum of every color; light is allowed to pass through the substrate without appreciable scattering of light. The opposite property of translucency is opacity or non-transparent. Examples of transparent substrates include, but are not limited to, glass or quartz.

Under conditions sufficient to: A phrase that is used to describe any environment that permits the desired activity.

### II. General Description

Disclosed herein are systems and methods for the detection, analysis, and manipulation of microscopic specimens, such as single molecules, single small particles, or small quantities of matter such as DNA as the samples are passed through a nanoscale gap in a nanofluidic channel. In particular, disclosed are new systems and methods to reliably mount a single molecule between a pair of metal electrodes and to allow both electrical and optical characterization of the structure and dynamics of the molecule. The molecule mounting event can be simultaneously detected by the ionic current changes inside the nanofluidic chambers, and the tunneling current across the metal nanogap; providing unambiguous analysis of background free signals. This is believed to be the first and only demonstration of about 100% correlated identification of DNA translocation events.

The disclosed technology improves upon previous efforts to put a single molecule between a metal junction, which are problematic since molecules cannot be controllably mounted and every junction, as it forms, is never predictable or reproducible. Conventional methods are based on recording all random events and data mining afterwards. All existing techniques of single-molecule conductance measurements are based on recording all random events and data mining afterwards. There have been only a few reports on integrating tunneling current detection with a nanopore/nanochannel device to detect translocating DNA molecules. In these studies, the tunneling gap is fabricated using focused-ion-beam, electron-beam enhanced deposition, or electromigration, with alignment to a single pore on a membrane structure. The yield was very poor, with significant problems of leakage currents. The molecules that pass through the nanopore may not necessarily go through the tunneling gap, and the tunneling current detected may not reflect events related to translocation. A few proof-of-concept examples to integrate electrodes with nanopore devices on a scalable chip based on top-down lithography also reflect serious challenges in insufficient size and alignment control.

It is therefore highly desired to have a new design of device structure to precisely deliver and detect single molecules at a tunneling gap for unambiguous and reproducible characterization. In the present system, the nanofluidic system and embedded nanogap gives the unprecedented capability of background-free identification of individual mounting events. Specifically, when the nanogap is formed, during measurement, the size and geometry of the nanogap is fixed with no uncertainty as introduced in servo controls in a STM setup. In addition, the molecules that will bind to the nanogap have a clear delivery time frame as controlled by the nanofluidic system, and the binding rate can be tuned by the concentration of the molecule as well as the driving voltage between the two chambers which provides electric and electroosmotic control. This is different from all the existing techniques where molecules are completely randomly introduced by diffusion into an unknown geometry. Last, compare to all other methods, the dimension of the nanogap is controllably confined within a cavity determined by the fabrication process and later electrochemical deposition process, which enables limiting binding events to happen at single molecule level due to spatial exclusion. All these lead to significantly higher quality of characterization for single molecule properties. The disclosed technology provides a method for measuring conductance and optical properties of any molecules as they bind to the nanogap. The disclosed technology allows the size of the nanogap to be tuned to fit the molecule under characterization. Typically, protein molecules will be 5-10 nm, with larger ones approach 100 nm order. In some embodiments, such as DNA/RNA molecules, depending on how they will bind to the surface, the distance will be about 1-2 nm for cross-section measurement, or about 10 to about 100 nm for cross-chain measurement. For simple molecules, such as 1, 4-benzenedithiol which binds to the surface through its -S atom at both ends, the gap size can be about 1 nm. Thus, the disclosed technology allows for electrical and optical characterization of a much broader range of molecules.

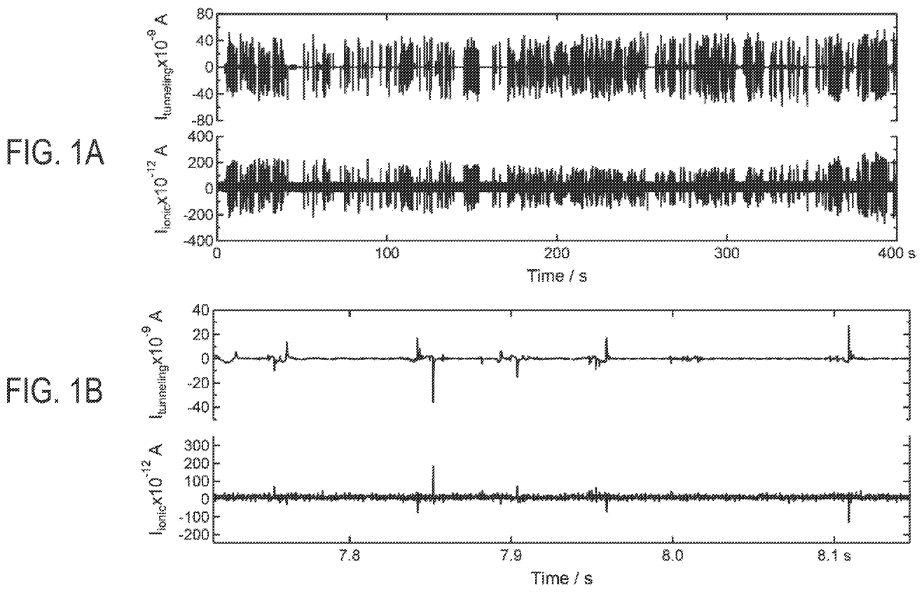

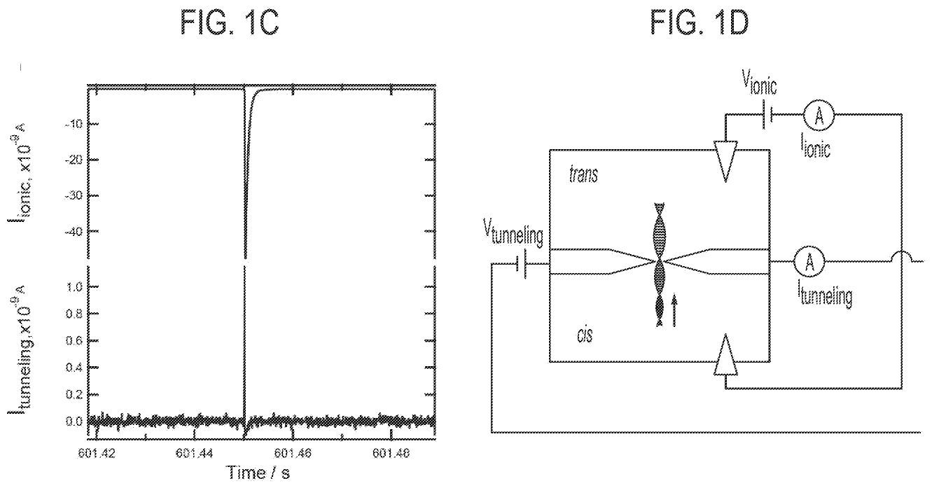

As shown in FIGS. 1A-1D, correlated translocation events and tunneling signals were obtained and believed to be the first and only demonstration of ˜100% correlated detection of translocation events in both signal channels. In addition, the nanofluidic system also enables real-time changing of molecules delivered to the tunneling gap in physiological environment for more dynamic studies in their natural configurations.

An advantageous design feature of the disclosed system is to integrate inside the confined planar structure of fluidic channels on transparent substrates with feed-back controlled electrochemical deposition, a self-aligned tunneling junction at the narrowest position of the channel.

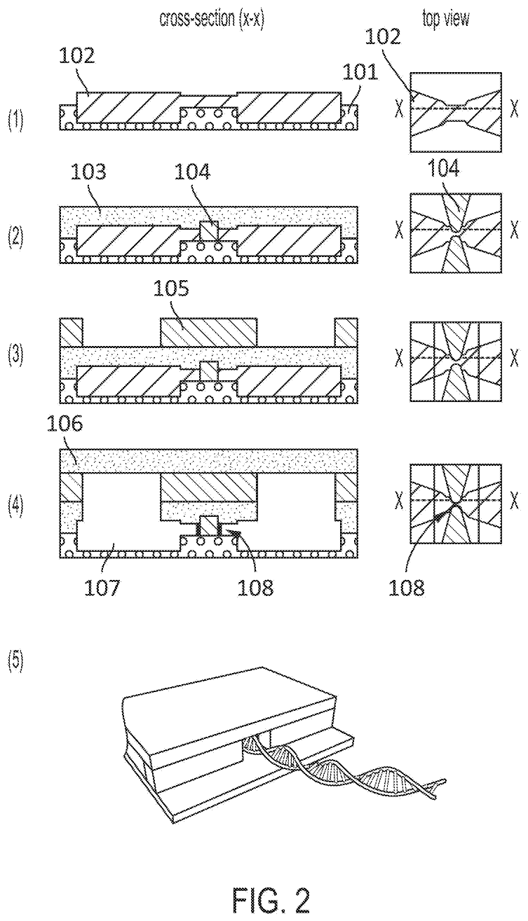

As shown in FIG. 2, methods of fabrication of a device, can include deposition of one or more sacrificial layers 102 on a transparent substrate 101, such as glass or quartz. In embodiments, the sacrificial layers are composed of two sections: Section I is defined close to the position of the tip of the electrodes 104, shown as the center thinner part in FIG. 2, which typically has a thickness of about 5 to about 100 nm that is close to the size of the diameter of the molecules of interest for measurement. Section II is defined at the outer sides of Section I, shown as the thicker parts in FIG. 2. In embodiments, Section II constitutes the space that joins the fluidic chambers/channels at the outside with the inner space, as defined by Section I, at the tip of the electrodes, where the core deposition of metal is performed and eventually where the binding events and measurements happens. In embodiments, the thickness of Section II is between about 100 nm and about 1000 nm. If no optical access is required, other substrates with an insulating surface can be used, such as silicon coated with an insulation layer of silicon oxide or silicon nitride. The sacrificial layer defines the guiding channel leading to the tunneling junction (e.g., Section II on both left and right sides in the drawing), and the height (such as a height of about 5 nm to about 100 nm matching the size of molecules of interest) of the confined space (Section I) where later electrochemical deposition will happen (center portion in the drawing).

In embodiments, in a second step, a pair of electrodes 104 made of gold, palladium, platinum, iridium or their alloys, or a combination thereof with spacing between about 500 nm and 1 μm is fabricated on top of the center region of the sacrificial layer. Then a top dielectric passivation layer 103, such as one or more layers of HfO₂, SiO₂, Si₃N₄, or other dielectric materials, is deposited to seal the metal surface as the passivation layer. In embodiments, the passivation layer has a thickness of about 10 to about 1000 nm, such as a thickness of about 100 to about 200 nm.

In embodiments, in a third step, a top layer made of either polymer such as SU-8 or dielectric such as SiO₂ or Si₃N₄ is patterned to construct the shape of the channels 105 on top of the dielectric passivation layer to both protect the electrodes underneath and serve as a mask for the etching process in the next step. It is contemplated that the shape of channels can vary for best efficiency of molecule delivery to the gap, as well as optimal translocation control. The core dimension of the pattern of the channels is the lateral width of the barrier between channels, below which the nanogap and sacrificial layers are sealed. In embodiments, the closest distance between the cis- and trans-channels/chambers, defined by the SU-8 polymer or dielectric in this step, is between about 1 and about 100 micrometers, for higher yield and less diffusion resistance for effective translocation control.

In embodiments, in a fourth step, a reactive ion etching process is used to expose the sacrificial layer below the open window area in the polymer mask, and a top cover 106, such as a top cover made of Polydimethylsiloxane (PDMS) or resin, is attached to seal the channels. The remaining passivation layers are then chemically etched by filling the channels with chemical etchants which can etch away the sacrificial layers 102 for construct the chamber and channels 107a and 107b that leads to the metal electrodes. The typical materials used for the sacrificial layers 102 are chromium, aluminum and magnesium. Correspondingly, the etchant for these materials should be chromium etchant, aluminum etchant and magnesium etchant.

In embodiments, in a fifth step, an electrochemical deposition is used to deposit an additional metal layer 108 of gold, palladium, platinum, iridium or their alloys, or a combination thereof onto the two existing metal electrodes which are now exposed in the confined space. The z-thickness (perpendicular to the surface of the substrate) of the newly deposited metal is confined by the space near the exposed electrode tip. In embodiments, this is defined by the Section I of the sacrificial layer 102, which is about 5 nm and about 100 nm. The extending thickness of the deposited material (parallel to the surface of the substrate, extending from the original tip surface of the metal electrodes), is defined by the time and current of the electrochemical deposition, such as between about 1 nm and about 500 nm.

In embodiments, a feedback circuit is used to control the deposition process such that the distance between the metal electrodes will be finely tuned to fit the size required for mounting molecules for characterization, such as between about 1 nm and 100 nm, between about 10- 50 nm, between about 1-20 nm, between about 20-60 nm, including, but not limited to between 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99 or 100 nm. In embodiments, the smallest size of the gap is comparable to the diameter of a single biopolymer. For example, the diameter of a single strand DNA molecule is about 1.0 nm. In embodiments, the largest size of the gap is comparable to the diameter of the diameter of the three-dimensional size of a molecule, such as a protein molecule, that is to be characterized, such as on the order of about 5 nm to 10 nm, with larger ones close to 100 nm.

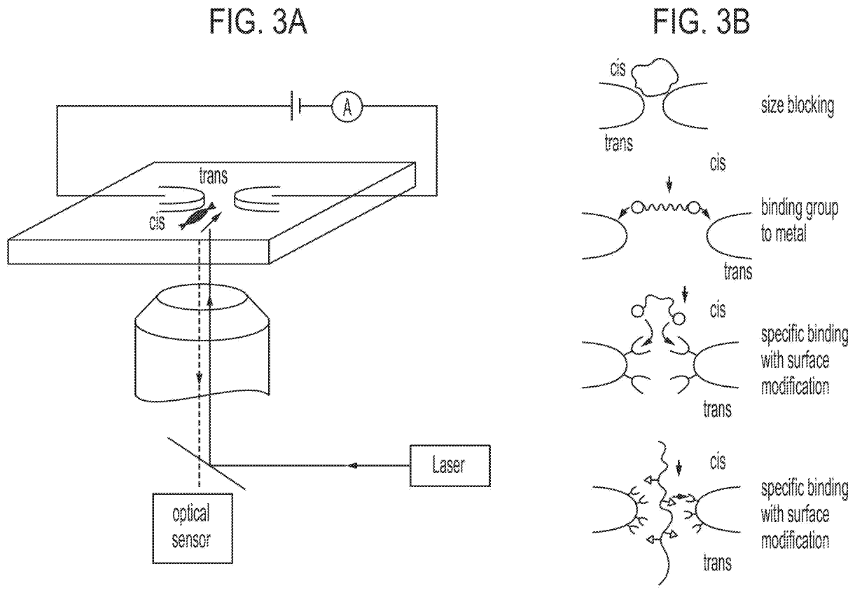

A representative measurement system to use the devices prepared by the disclosed methods of fabrication in accordance with embodiments disclosed herein is provided in FIG. 3A. In embodiments, the device can be mounted on a microscope where the objective lens can focus on the nanogap through the transparent substrate, for tracking the motion and translocation of molecules inside the channel with fluorescence signals. The lens can also be used for detecting Raman signals from the gap as the molecules passes through the electrodes. The electrodes will be connected to a voltage source and an electrometer to record the tunneling signal across the gap. Between the cis- and trans-chamber, two electrodes can be used to apply a bias potential of 10-1000 mV for driving the molecule through the gap.

In embodiments, as shown in FIG. 3B, as a molecule analyte is delivered to the cis-chamber on one side of the nanogap, the molecule is guided through the nanogap by a bias, such as between 10-1000 mV, applied between the cis- and trans-chamber. It is contemplated that the bias can be tuned to satisfy desired speed of translocation. There are several methods to mount the molecule to the metals, as shown in FIG. 3B, including (1) simple blocking by sizes of the molecule, (2) modifying the molecule to have binding sites that can form chemical bonds to the metal such as thiol groups that can bind to gold surface, (3) modify the surface of the metal so that it will have specific binding sites that will recognize specific functional groups on the molecule at the ends, or (4) along the sides of the molecules. The binding site in these configurations can be valence chemical bonds, such as the S—Au/Pt/Pd between sulfhydryl group and the metal such as Au, Pt and Pd when they get in contact. For example, the lysines in protein molecule can be modified by thiolation reagents to produce free sulfhydrl groups which forms valence chemical bonds with the metal surface. The binding site can also be designed to be specific high-infinity interactions between proteins and functional groups, such as the avidin-biotin interaction. For example, on the substrate thiolated biotin may be included to modify the metal surface through the S—Au/Pt/Pd bond, exposing biotin group into the medium. The protein molecule can be then linked with streptavidin will bind to the biotin groups when it comes to the nanogap. Other interactions such as hydrogen bonds etc can also be used.

It is contemplated that a mounting event can be detected both by the ionic current between the cis- and trans-chambers and the tunneling current between the metal electrodes as shown in FIG. 1D, and the conductance of the molecule can be evaluated when such event is detected. In addition, optical characterization such as tip-enhanced Raman spectrum can be performed through the transparent substrate to understand the dynamic structure of the molecule.

In some embodiments, the present disclosure provides a method for sampling/characterizing molecules, small particles or small samples of material which comprises delivering a sample, such as a molecule analyte, into the cis-chamber on one side of the nanogap and guiding the sample, such that molecule analyte travels through the nanogap by a bias, such as a bias between about 1 and about 1000 mV, applied between the cis- and trans-chamber.

In some embodiments, the present disclosure presents a measurement device for analyzing samples consisting of single molecules, small particles, or small quantities of matter. The molecular measurement device includes at least one nanofluidic channel through which a solution containing a sample to be analyzed can flow, and a pair of electrodes defining a nanogap across the nanofluidic channel through which the sample is passed. In embodiments, the size of the nanogap is selected based on the molecular size of the matter samples to be observed with the apparatus, and as such, permits only a single matter sample to pass through the nanogap at a time. In embodiments, the distance between electrodes gets in the 1-100 nm range to form a self-aligned nanogap with the narrowest bottleneck in the path between the two said channels/chambers. It is contemplated that the nanogap can be tuned during the electrochemical deposition process to address different properties for molecules of different size and geometry. In embodiments, the sample includes DNA, such as single stranded DNA and/or double stranded DNA. In embodiments, the sample includes RNA. In embodiments, the sample includes protein. Other embodiments include small molecules, any number of various polymers, and the like.

The nanogap provides an output representative of an environmental condition within the nanogap which changes in response to the presence of a sample within the nanogap. These environmental characteristics may be electrical or optical.

In a further embodiments, the present disclosure provides a method to measure the conductance and optical properties such as tip-enhanced Raman spectrum from single molecules by detecting the individual mounting event of single molecules by the correlated ionic current between the said channels/chambers and the tunneling current between the said metal electrodes (e.g., through the defined nanogap), and then perform the electrical and optical characterization.

In another embodiment, a method of making a nanopore device that includes a nanopore and a tunneling junction, comprises depositing a first sacrificial layer defining a final cavity for electrochemical deposition and depositing a second outer sacrificial layer defining a final nanofluidic space connecting the nanopore to cis- and trans-chambers onto a substrate layer; positioning a pair of electrodes with a spacing of about 500 nm to 1 μm on top of the first sacrificial layer; depositing a passivation layer on top of the pair of electrodes, the first sacrificial layer, the second sacrificial layer and the planar substrate to seal the pair of electrodes and the first and second sacrificial layers; conducting a dry etching process to remove one or more sections of the passivation layer to produce access windows to the second sacrificial layer; attaching a top cover atop the passivation layer remaining following the dry etching process; chemically etching the first and second sacrificial layers to construct the final cavity and the final nanofluidic space; and narrowing the spacing between the pair of electrodes by a process of controlled electrodeposition of a metal onto the pair of electrodes to form the nanopore and the tunneling junction.

In a first example of the method of making the nanopore device, the method further includes wherein the first sacrificial layer is comprised of Cr and is between 10-20 nm in thickness.

A second example of the method of making the nanopore device optionally includes the first example, and further includes wherein the second sacrificial layer is comprised of Al and is about 200 nm in thickness.

A third example of the method of making the nanopore device optionally includes any one or more of the first and second examples, and further includes wherein the top cover is comprised of PDMS.

A fourth example of the method of making the nanopore device optionally includes any one or more of the first through third examples, and further includes wherein the process of controlled electrodeposition further comprises conducting a pulsed electrochemical deposition operation comprising a pulse width of 50 ms or less and a rest period of between about 500 ms and 2 seconds between pulses.

A fifth example of the method of making the nanopore device optionally includes any one or more or each of the first through fourth examples, and further includes wherein the pulse width is between 1 ms and 5 ms.

A sixth example of the method of making the nanopore device optionally includes any one or more or each of the first through fifth examples, and further includes wherein the pulse width is between 1 μs and 500 μs.

A seventh example of the method of making the nanopore device optionally includes any one or more or each of the first through sixth examples, and further includes wherein the pair of electrodes are comprised of gold, palladium, platinum or combinations thereof.

An eighth example of the method of making the nanopore device optionally includes any one or more or each of the first through seventh examples, and further includes wherein the metal used to narrow the space between the pair of electrodes is Ni, Co, Ni alloy, Co alloy, gold, palladium, platinum, iridium or their alloys, or combinations thereof.

A ninth example of the method of making the nanopore device optionally includes any one or more or each of the first through eighth examples, and further includes wherein narrowing the spacing between the pair of electrodes by the process of controlled electrodeposition further comprises establishing a bias of about 50-100 mV between the cis- and trans-chambers.

A tenth example of the method of making the nanopore device optionally includes any one or more or each of the first through ninth examples, and further includes wherein narrowing the spacing between the pair of electrodes by the process of controlled electrodeposition further comprises providing the metal in both the cis- and trans-chambers.

An eleventh example of the method of making the nanopore device optionally includes any one or more or each of the first through tenth examples, and further includes wherein narrowing the spacing between the pair of electrodes by the process of controlled electrodeposition further comprises providing the metal in just one of the cis- and trans-chambers.

A twelfth example of the method of making the nanopore device optionally includes any one or more or each of the first through eleventh examples, and further includes wherein narrowing the spacing between the pair of electrodes by the process of controlled electrodeposition further comprises repeatedly narrowing and then expanding the spacing between the pair of electrodes any number of time via repetitive reversing of a polarity of the pair of electrodes.

A thirteenth example of the method of making the nanopore device optionally includes any one or more or each of the first through twelfth examples, and further includes wherein narrowing the spacing between the pair of electrodes by the process of controlled electrodeposition is used to create a final spacing between the pair of electrodes of 1 nm to 100 nm. In some examples, the final spacing is 1 nm to 20 nm. In still other examples, the final spacing is 1-2.

In yet another embodiment, a method of using nanopore devices of the present disclosure to enrich analyte molecules in the cis- chamber prior to allowing translocation of the analyte molecules through the nanopore and tunneling junction comprises applying a first driving bias for a first duration of time and then switching the driving bias to 0 mV. In an example, the first driving bias is about −200 mV, and the first duration of time is about 50 minutes.

### EXAMPLES

The Examples below further serve to illustrate the above-disclosed subject matter in greater detail. It may be understood that each of the Examples below may represent or correspond to a particular embodiment. Thus, it may be understood that the Examples are meant to be representative, and other variations and embodiments are within the scope of this disclosure.

### Example 1

### Methods and Materials

### Fabrication of Nanopore Device

A 170 um thick 1-inch quartz coverslip (Electron Microscopy Sciences, Item#: 72256-02) was cleaned with piranha (3:1 concentrated sulfuric acid (Sigma, SKU 258105) and 30% hydrogen peroxide (GFS chemicals, SKU 43971)). Three structure layers were fabricated through conventional photolithography and thermal/E-beam evaporation in the following order: Cr sacrificial layer (20 nm), Al sacrificial layer (2 nm Cr/240 nm Al/2 nm Cr), and Au transverse electrodes (2 nm Cr/40 nm Au/2 nm Cr). Before the Al sacrificial layer metallization, a 200 nm deep SiO2 reactive ion etching (ME) was performed to embed the fluidic chamber/guidance into the quartz substrate. Finally, a 100 nm HfO2 insulating layer was coated on the wafer surface by atomic layer deposition (ALD). The fabrication quantity can also be scaled up and performed on a quartz wafer 500-μm thick 4-inch quartz wafer (University wafer, Item #:518).

### Nanopore Device Assembly

The microfluidic channel was defined by RIE to selectively remove HfO2 with a photoresist RIE mask. After the removal of photoresist RIE mask, SU8 polymer supporting structure was constructed through a modified low stress protocol. Firstly, the chip was cleaned and dehydration baked at 180° C. for 30 min before SU-8 spin coating. SU-8 2025 (MicroChem) was spin-coated for 40 s at 2000 rpm on the device chip and baked at 57° C. overnight. Secondly, the SU-8 layer was then patterned as an intermediate layer on top of the remaining HfO2 layer via lithography. After the lithography exposure, post exposure bake (PEB) was performed at 57° C. for 1 hour with slow ramping rate. The polymer is developed in SU-8 developer (MicroChem) for 10 min, followed by two gentle rinsing processes in IPA (CSI, 6305V) and one gentle rinsing process in Milli-Q water (Milli-Q Advantage A10 system), and the chip was air dried in clean environment. Finally, the developed device chip was hard baked at 180° C. degree in oven for 1 hour with a slow ramping speed. The SU-8 surface was functionalized with APTES (Sigma-Aldrich, SKU 440140) to improve the adhesion between PDMS (Dow Corning, Sylgard 184) and SU-8 by immersing the chip in a 5% (v/v) APTES ethanol solution for 20 min immediately after a 2 min oxygen plasma cleaning. The APTES functionalized SU-8 surface was then rinsed in 95% ethanol followed by a dehydration bake at 120° C. for 30 min. A flat PDMS sheet with fluidic inlets (H×W×L 0.5×1×1 cm³) were sonicated in ethanol (Sigma-Aldrich, SKU 493511) and used as the top seal of the assembled microfluidic system. The PDMS sheet was then aligned and placed on the SU8 structure with liquid PDMS as sealant. The assembled device chip was then baked at 120° C. degree in oven for 1 hour with a slow ramping speed in order to cure the liquid PDMS and seal the microfluidic channels. The assembled device chip was fixed on the surface of a customized printed circuit board (PCB) and connection was made through a wire bonder. Finally, PE tubing were inserted into the holes on the PDMS block.

### Sacrificial Structure Wet Etching

The wet etching of the sacrificial structure comprises at least three steps. Firstly, a commercial Chromium etchant (Sigma-Aldrich, SKU 651826) was pumped through the microfluidic channels for 10 min to remove the Cr layer on top of the Al sacrificial layer. Secondly, a commercial Aluminum etchant (Transene, Al etchant type D) was pumped through the microfluidic channels to remove the Al sacrificial layer until the Al sacrificial layer was etched completely. Finally, The Cr etchant was pumped through the microfluidic channels to remove the center Cr sacrificial layer until the current between the transverse electrodes shows a complete disconnection. A 1 hour Milli-Q water flushing was applied between each step in order to remove the etchant residue and precipitations. Phosphate buffer (PB) (5 mM KH₂PO₄ (J. T. Baker, SKU 324601) and 5 mM Na₂HPO₄ (Sigma-aldrich, SKU 71643)) was then pumped into the device before and after the wet etching. A Keithley source measurement unit (Keithley, Model #:2636B) was used to characterize the ionic conductance between two microfluidic chambers through Ag/AgCl salt bridge electrodes. Combining IV scan results before and after the sacrificial structure etching, the ionic conductance property of the initial nanopore device was characterized.

### Electrochemical Deposition of the Nanopore

Two Ag/AgCl salt bridge electrodes connect to two microfluidic channels on both sides of a single device, allowing an ionic current monitoring during the electrochemical deposition. The transverse electrodes connect to a preamplifier (FEMTO, Model #:DLPCA-200) and a lockin amplifier (Stanford Research System, Model #:SR865) in order to monitor the tunneling current between the transverse electrodes during the electrochemical deposition. During the deposition, the electrochemical deposition solution (18.5 mM KAu(CN)2 (Sigma-Aldrich, SKU 379867) and 180 mM potassium citrate (GFS Chemcials, SKU 60591)) was introduced in both microfluidic channels. A deposition pulse was applied on one salt bridge electrode and a follow up voltage with a 50 mV potential difference was applied on the other salt bridge to maintain a constant bias between two microfluidic channels. An alternating current (AC) voltage was applied on between the transverse electrodes. The deposition process was controlled by a customized Igor program (WaveMetrics, Igor Pro 8), which reverses or stops the deposition when the tunneling current amplitude reaches threshold values. The tunneling conductance was then tuned to around 1 nS by manually applying oxidation pulse in order to reach the readout level as a typical scanning tunneling microscopy. After the deposition, the microfluidic channels were flushed with PB buffer to get rid of the deposition solution residue. Then 50 μM PEG thiol (Sigma-Aldrich, SKU 729108-1G) aqueous solution was introduced in both microfluidic channels in order to coat the Au surface overnight. There was a cross-chamber bias of 500 mV applied to drive the PEG thiol through the nanopore in order to improve the coating on gold tip surface. After the coating, the microfluidic channels are flushed with PB for 1 hr to remove PEG thiol residue.

### DNA Translocation Measurement

Lambda DNA solutions with different concentrations were prepared from commercial products (Sigma-Aldrich, SKU 10745782001) with filtered PB buffer. During a DNA translocation test, the Lambda DNA solution was introduced into one microfluidic channel (cis channel) and the pure PB buffer was introduced into the other microfluidic channel (trans channel). One Ag/AgCl salt bridge reference applied a negative bias in the cis-chamber and the other Ag/AgCl salt bridge reference applied a constant 0V in the trans-chamber. The transverse electrodes applied desired gap bias perpendicular to the DNA translocation direction. The ionic current measurement between two microfluidic channels was performed by a patch clamp amplifier (HEKA patch clamp, Model # EPC 800), and the tunneling current measurement between the transverse electrodes was performed by a preamplifier (FEMTO, Model #:DLPCA-200).

### Example 2

### Design and Preparation of the Nanopore Chip

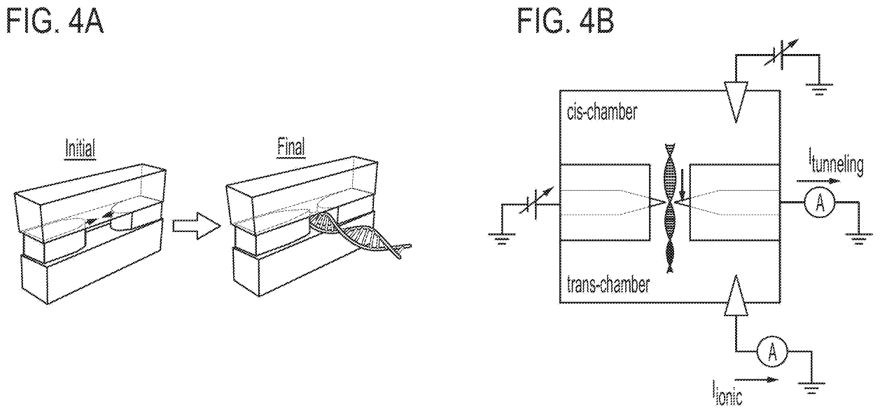

In an example embodiment, scalability of fabrication and quality control for individual devices were addressed by preparing the nanopore in two stages. As shown in the schematics in FIG. 4A, an initial structure served as a starting point, where a pair of electrodes were sandwiched between dielectric passivation layers to form a confined cavity. The starting distance between the electrodes was typically set to 1 and the thickness of the cavity was typically 10˜20 nm, which can be easily prepared through standard top-down lithography protocols as shown later. Next, the gap between the electrodes can be finely reduced in a reversible and controllable way (e.g., controlled electrochemical deposition) to construct a tunneling junction, which simultaneously forms the nanopore device at the narrowest position. The electrodes and the dielectric layers separate the chip space into two lateral chambers, with the nanopore and the tunneling junction self-aligned in between, such that any molecule translocating from one chamber to the other through the nanopore must pass between the electrodes. FIG. 4B shows the typical setup for the recording experiment, where the DNA molecule is driven from cis-chamber to trans-chamber by a negative bias, and the ionic current I_{ionic} is recorded. At the same time, a bias is applied between the transverse electrodes, and the current across the tunneling junction I_{tunneling} is recorded to track the same translocation event.

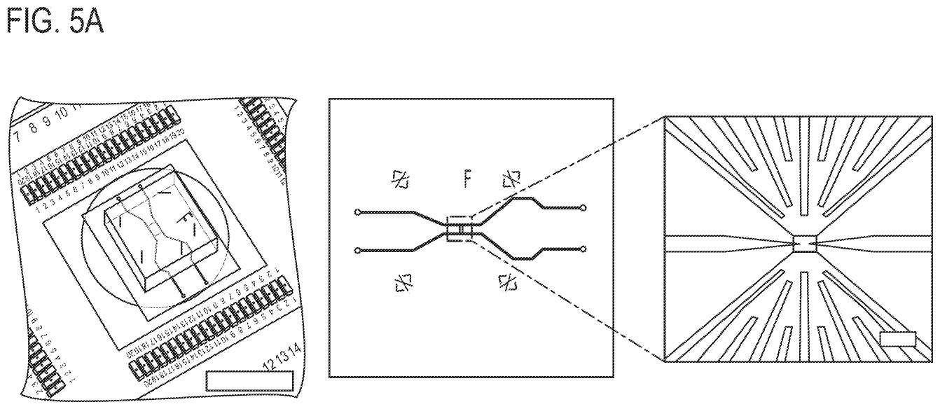

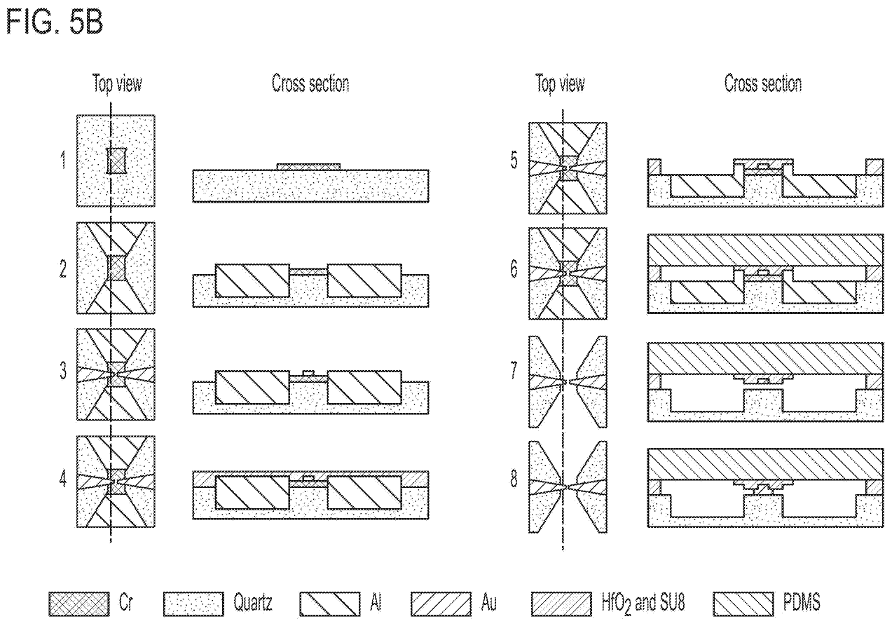

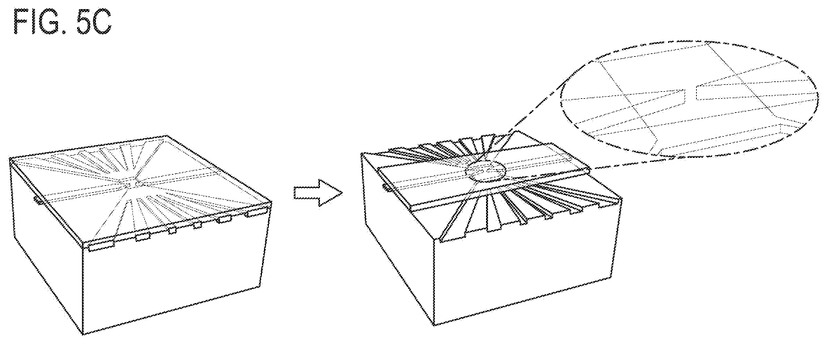

The nanopore devices were fabricated typically on a 1 inch×1 inch quartz cover slip of 170 μm thick which has the advantage of providing direct optical access to individual devices for single molecule imaging during recording experiments. Scaled-up fabrication on a 4-inch quartz wafer has also been achieved, resulting in a thicker chip (550 μm). Pictures of the bare chip and the assembled setup with PDMS chambers mounted on a customized printed circuit board (PCB) are shown in FIG. 5A. Specifically, the left image at FIG. 5A depicts an image of an assembled nanopore chip mounted on a customized printed circuit board with optical access to the devices. Scale bar: 1 cm. The middle image at FIG. 5A depicts a picture of the nanopore chip on a tissue paper based on a 1 inch×2 inch quartz cover slip of 170 μm thick. The right image at FIG. 5A depicts a magnified image of one initial nanopore device of the present disclosure. Detailed fabrication procedures are explained in Example 1. Here the key steps are briefly summarized in the following sections. The following sections are discussed with reference to FIG. 5B, steps 1-8. Briefly, steps 1-6 refer to key fabrication steps of the nanopore device including construction of the initial device, and steps 7-8 refer to the final preparation. Drawings are not to scale for clarity. The dotted lines shows the position of the cross section. 1: Center Cr sacrificial layer (10-20 nm thick) defining the final cavity for electrochemical deposition; 2: Outer Al sacrificial structures (˜200 nm thick) defining the final nanofluidic space connecting the nanopore to cis- and trans-chambers (not shown); 3: Initial Au electrode pair with a starting gap distance of 1 μm. 4: Passivation layer made of HfO2 and SU8 to seal the electrodes and the sacrificial layers. 5: Access windows to the Al sacrificial layer opened by masked dry etching process. 6: Top sealing by PDMS to construct the cis- and trans-chambers. 7: Two-step chemical etching of the Al and the Cr sacrificial layers to construct the nanofluidic channels and the cavity between the Au electrodes. 8: The gap between electrodes is narrowed by controlled electrodeposition of Au onto the existing metals in the inner cavity to form the final nanopore and tunneling junction. FIG. 5C depicts 3D models of the nanopore device before etching (left) and after preparation for recording (right). The inset illustrates a DNA passing through the final nanopore and tunneling junction.

### Layout of Sacrificial Structures

The fabrication begins with the 10 μm×10 μm central sacrificial layer made of 10-20 nm thick Cr through conventional photolithography and metallization (FIG. 5B, Step 1). The Cr layer defines the nanoscale cavity in the final steps where confined metal deposition happens. Next, the areas on the substrate adjacent to the central sacrificial layer is etched down by reactive ion etching (ME) to create a set of 200 nm deep fan-shaped trenches with guides, and then over-filled by 220-240 nm Al to construct the outer Al sacrificial layer which overlaps with the Cr sacrificial layer at its edges (FIG. 5B, Step 2). These joint sacrificial structures extend 70-100 μm away from the center, and defines the continuous nanofluidic space in the final steps that connects the cis- and trans-chambers to the center region where nanopore is eventually formed.

### Construction of Initial Electrodes and Fludic Channels/Chambers

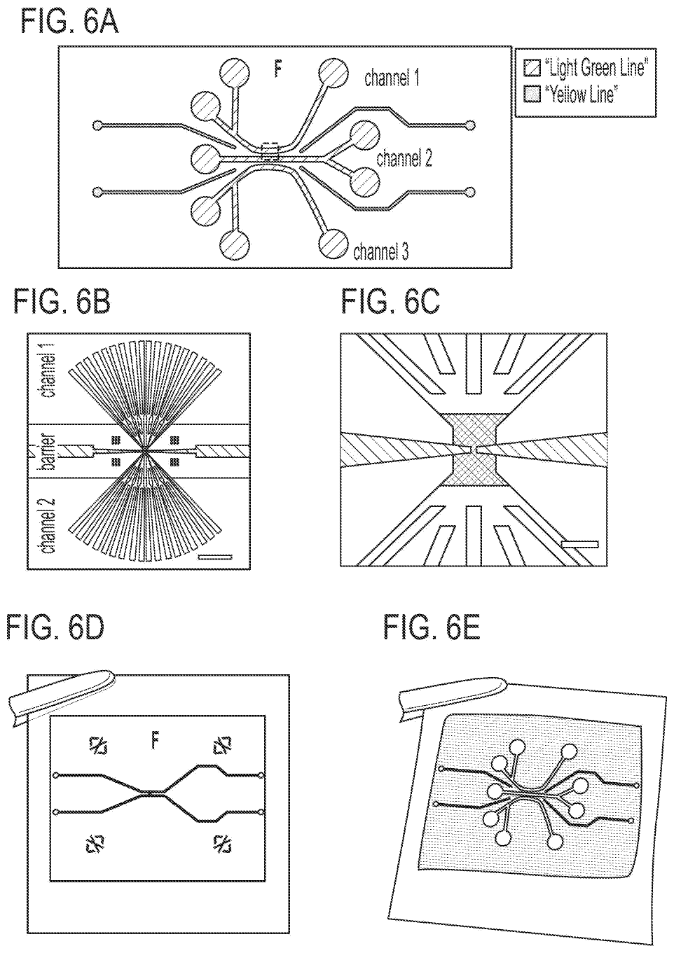

The pair of transverse Au electrodes are fabricated with their tips aligned with the center of the sacrificial layers and an initial gap distance of 1 μm. The whole surface of the chip is then fully passivated with 100 nm HfO2 by atomic layer deposition (ALD), followed by SU8 polymer layer through photolithography to construct the boundaries and supports of fluidic channels and chambers (FIG. 5B, Step 3-4). Before sealing of the channels and chambers with a PDMS sheet on the top, a masked RIE process is used to selectively open windows through the HfO2 passivation, just over the Al sacrificial layers such that the fluidic channels have access to the sacrificial structures (FIG. 5B, Step 5-6). At this point, the initial device is finished and can be safely stored in ambient environment for later use. The structure and images of the whole chip including the fluidic channels are shown in FIGS. 6A-6E, in which two nanopore devices are integrated on the same chip for demonstration purpose. More devices can be integrated for multiplexed recordings.

Turning briefly to FIGS. 6A-6E, depicted is the design of a planar gated nanopore device chip. FIG. 6A depicts a schematic of the microfluidic channels. The light green area is the microfluidic channels and the yellow line is the electrode pair. FIG. 6B shows a schematic of the structure of guidance channels before wet etch. Scale bar is 50 μm. FIG. 6C shows a schematic of an initial gap of electrode tips before wet etch. Scale bar is 2 μm. FIG. 6D-6E depict images of fabricated device chips before PDMS sealing. Specifically, FIG. 6D is a top-view of the chip showing the device structure on transparent 1 inch×1 inch quartz cover slip of 170 μm thick. FIG. 6E is a tilted view of the same chip under light illumination showing the microfluidic channels defined by 50 μm thick SU8 polymer.

### Preparation of Nanopore and Tunneling Gap Before Recording

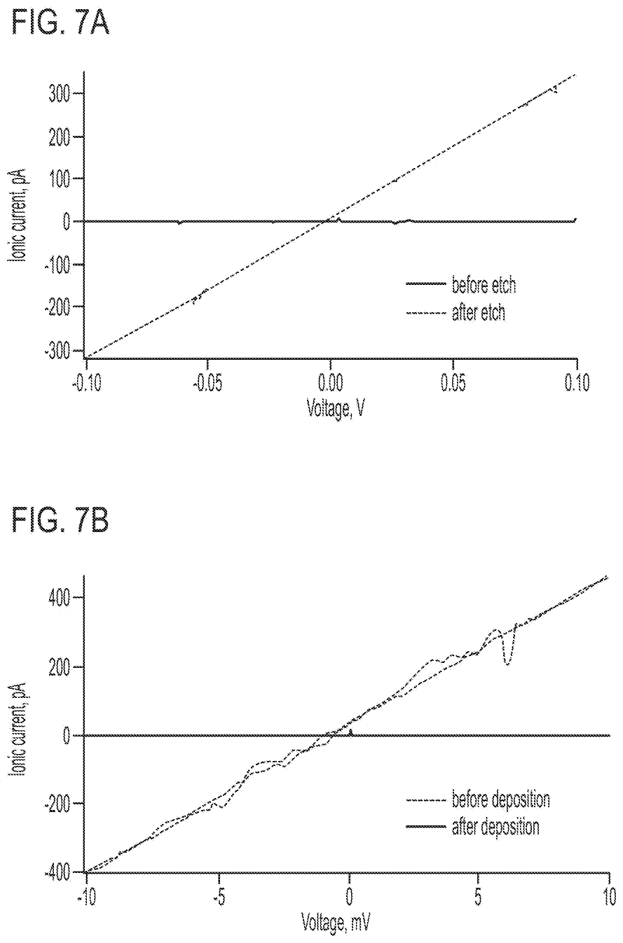

The initial devices have to be prepared to get the right dimensions just before being used for recording (FIG. 5B, Step 7-8, and FIG. 5C, which depicts a 3D model of the nanopore device before etching (left) and after preparation for recording (right). The inset at FIG. 5C illustrates a DNA molecule passing through the final nanopore and tunneling junction). Specifically, the sacrificial layers are first removed to construct a continuous space by properly feeding Al etchant and then Cr etchant through the fluidic channels, such that central nanoscale cavity around the electrodes is formed, with the nanofluidic channels on both sides connected to the cis- and trans chambers. Phosphate buffer (PB) containing 5 mM KH2PO4 and 5 mM NaHPO4 (pH 7.26) is used to flush the channels before and after each etching step, and the ionic conductance between then chambers are measured. Typical conductance before the final chemical etching is finished is 20˜30 pS as determined by the baseline of the electronics, and 2˜5 nS after the central Cr layer is completely removed (FIG. 7A), which is consistent with the simulation based on geometry and conductivity of PB (FIG. 7B).

Turning briefly to FIGS. 7A-7B, depicted are IV scans between the two fluidic chambers at different stages of the gap preparation. FIG. 7A shows IV scans before and after the sacrificial layer etching. The ionic conductance in phosphate buffer is 28 pS and 3.3 nS before and after the sacrificial etching. FIG. 7B shows IV scans before and after the gold deposition on tips. The ionic conductance in deposition solution is 43 nS and 9 pS before and after the metal deposition. Because of the concentration difference between the deposition solution and PB, the conductance measured in deposition solution is about 10 times higher than that measured in PB.

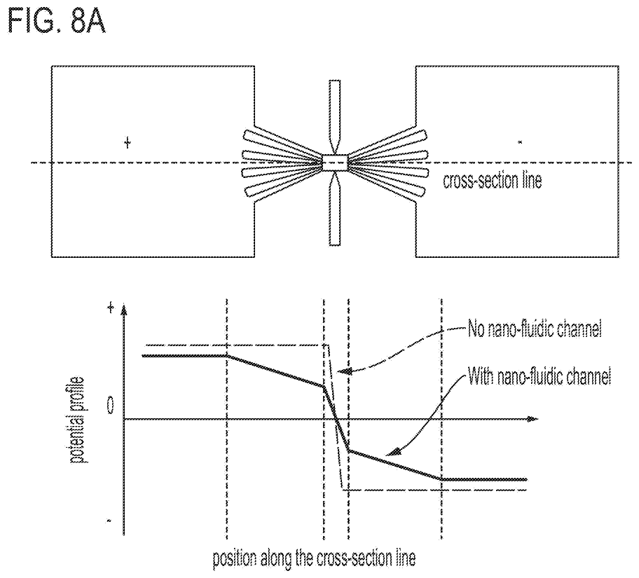

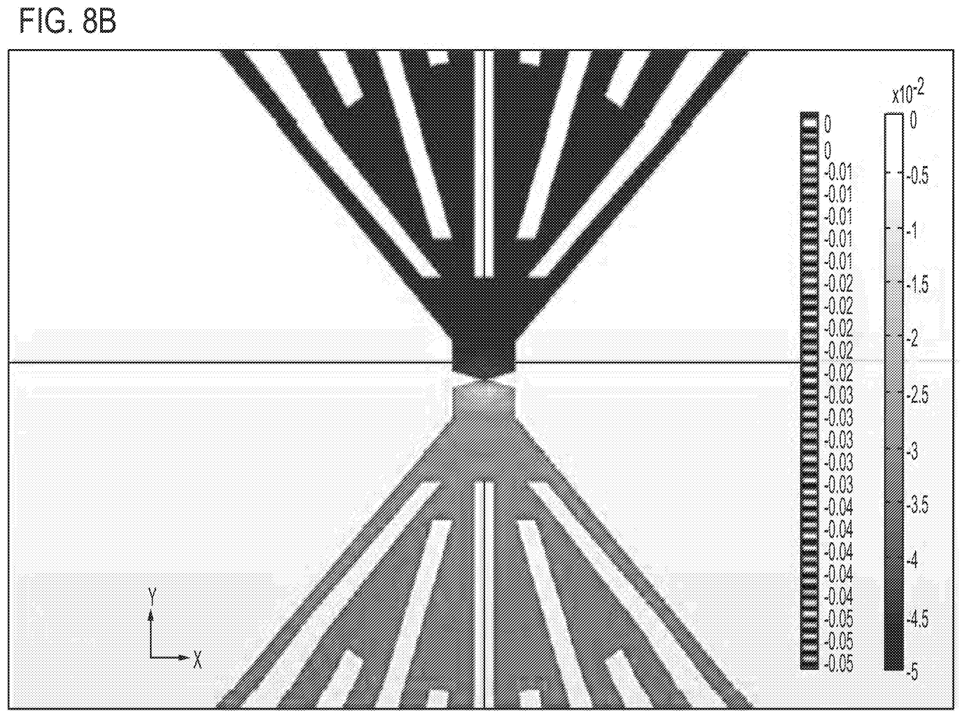

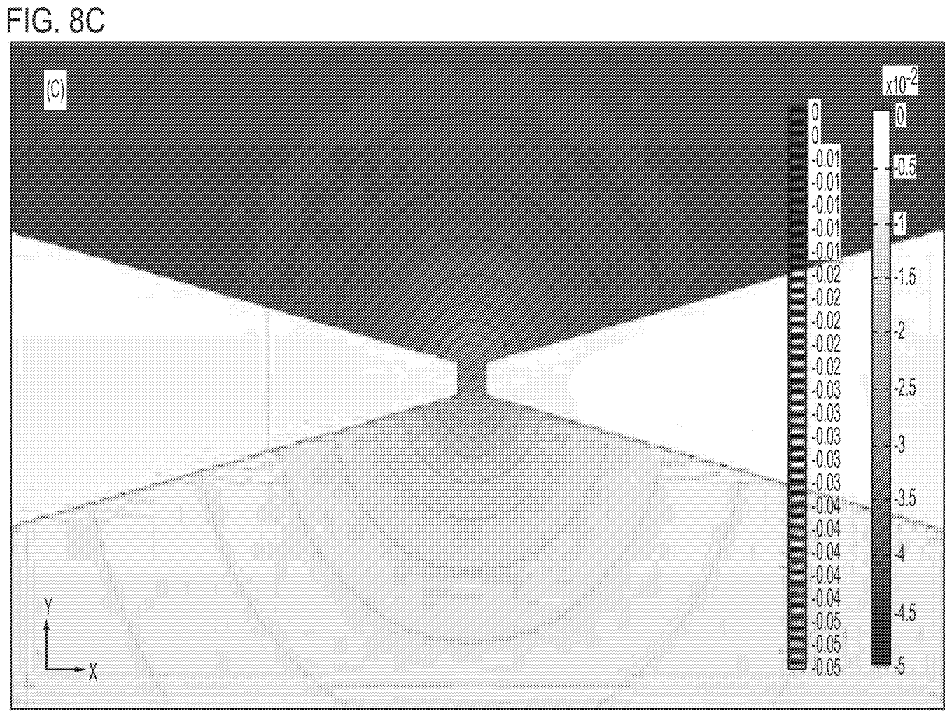

Turning briefly now to FIGS. 8A-C, depicted is the electric potential profile of the planar-gated nanopore device. Based on the channel geometry design and the ionic conductivity of phosphate buffer, the theoretical ionic conductance between two microfluidic chambers is 2.34 nS when channels are filled with phosphate buffer. FIG. 8A depicts a schematic of the channel design of the planar-gated nanopore device. Comparing to a conventional nanopore device structure, the planar gated nanopore device embedded within nanofluidic guiding channels may provide a modulated electric potential profile that stretches DNA molecules and enriches the DNA molecule concentration. FIG. 8B illustrates a simulation of the electric potential in the nanofluidic guiding channels when a constant cross-chamber voltage is applied. Shown is the electric potential profile in a color scale and equal potential lines are labeled. The trans-chamber (upper chamber) is grounded and the cis-chamber (the lower chamber) is at −50 mV. FIG. 8C illustrates a simulation of the electric potential at the nanopore (cross section of 20 nm×20 nm). The electric field increases gradually based on the nanofluidic channel design. The simulations with regard to FIGS. 8B-8C were done with COMSOL Multiphysics® version 5.3.

Next, using feedback control techniques adopted from previous studies (Sadar, J.; Wang, Y.; Qing, Q., Confined Electrochemical Deposition in Sub-15 nm Space for Preparing Nanogap Electrodes. ECS Trans 2017, 77 (7), 65-72; Qing, Q.; Chen, F.; Li, P.; Tang, W.; Wu, Z.; Liu, Z., Finely tuning metallic nanogap size with electrodeposition by utilizing high frequency impedance in feedback. Angew Chem Int Ed Engl 2005, 44 (47), 7771-5), which are hereby incorporated by reference in their entirety, the channels are filled with electrolyte containing 18.5 mM KAu(CN)2 and 180 mM potassium citrate, and the conductance between the transverse electrodes is monitored in real time to control electrochemical deposition of Au onto the existing electrodes with Ag/AgCl serving as the counter electrode. The cavity can be completely closed by the metal deposition as indicated by conductance between chambers returning to ·10 pS baseline in the electrodeposition solution (FIGS. 7A-7B), which suggests that there is no pinhole in the newly deposited structures. The final dimension of the nanopore and the tunneling junction can be finely and reproducibly tuned with a reversible pulsed deposition strategy as explained below.

### Example 4

### Characterization and Precise Control of the Nanopore and Self-Aligned Tunneling Junction

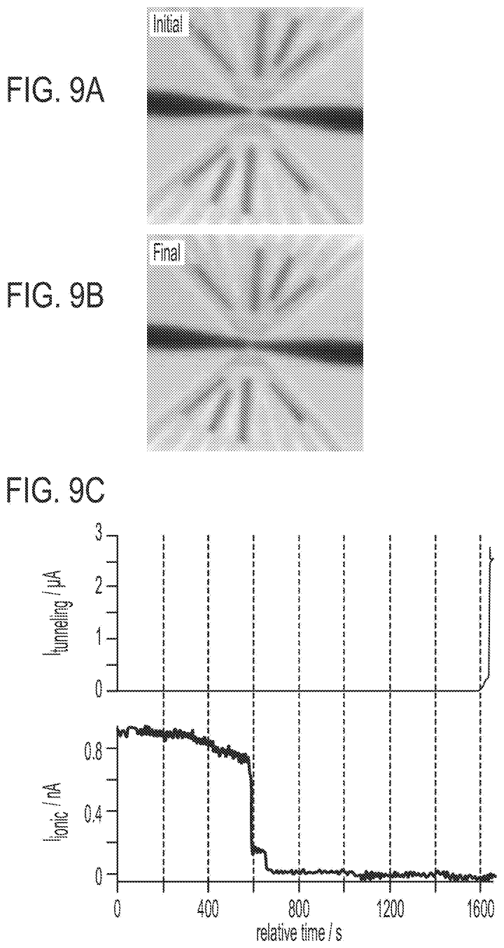

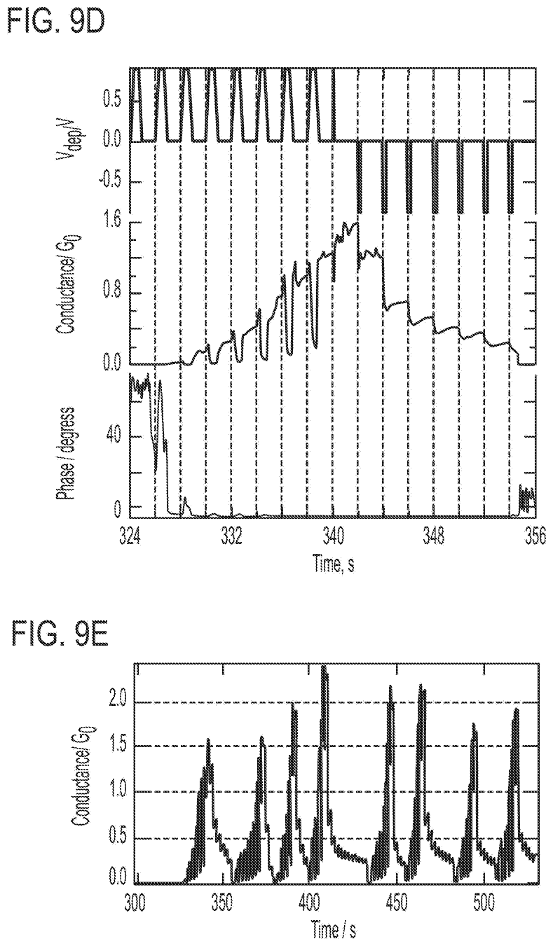

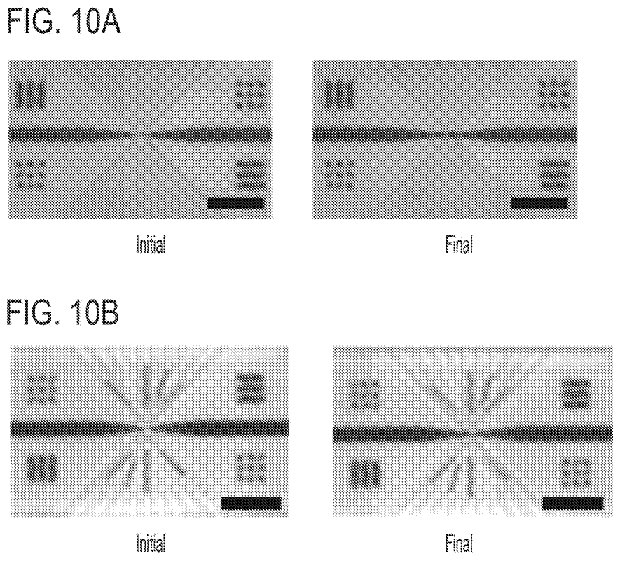

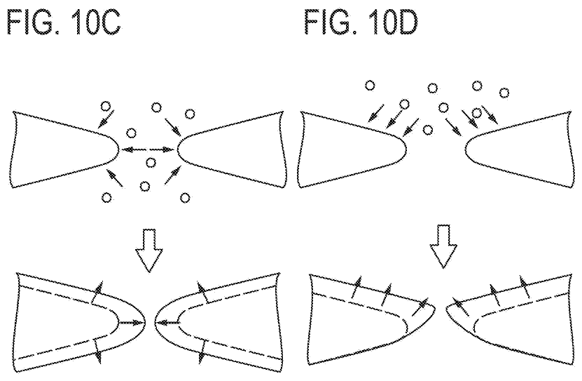

FIGS. 9A-9D depict reversible pulsed electrochemical deposition to precisely control the dimension of nanopore and tunneling junction. FIGS. 9A-9B illustrate optical images of the initial device (FIG. 9A) and the final tunneling junction (FIG. 9B). FIGS. 9A-9B show optical images from the backside of the cover slips of the initial transverse electrodes (FIG. 9A), and after the electrochemical deposition where the gap is closed under precise control (FIG. 9B). As the electrochemical deposition progress, one may typically observe first a drop in the ionic conductance between the cis- and trans chambers, then later an increase in the conductance between the transverse electrodes signaling a short (FIG. 9C). Specifically, FIG. 9C illustrates during a deposition as the electrodes become shortened, simultaneously recorded traces of currents between cis- and trans-chambers (I_{ionic}) under a bias of 50 mV and between transverse electrodes (I_{tunneling}) under a bias of 1.45 mV. It is herein recognized that if a constant deposition bias is applied, there will be significant side growth on the electrodes and it will take a very long time to short the electrodes. Without being bound to a theory, this is attributed to the quick exhaustion of Au(CN)2-ions near the tips of the electrodes in the confined nanoscale cavity. The deposition mostly happens on the outer edges of the electrode where the access to external ion supply is easier. Therefore, a pulsed deposition strategy was utilized to make the deposition at the tips more effective to close the gap. Namely, deposition potential was applied for a short period of time, and then the system was left to rest at a potential (the “rest” potential) where no Redox reaction is happening such that the ion concentration inside the central cavity can restore by diffusion. There is a clear correlation between the side growth on the electrodes and the width of the deposition pulses (FIGS. 10A-10B). A systematic comparison identified the optimal pulse width for effective tip growth to be 2˜50 ms with a rest potential period of ˜2 s.

Turning briefly to FIGS. 10A-10B, depicted are specific frames of time lapse recording during the metal depositions with different deposition pulses. FIG. 10A shows the tip shape before and after the deposition with a 400 ms, 950 mV square wave followed by a 1.6 s, 0 V resting potential. FIG. 10B shows the tip shape with a 2 ms, 950 mV square wave followed by a 1.998 s, 500 mV resting potential. The scale bar is 20 μm. With a short deposition pulse width of 950 mV and higher resting potential, the final deposition tip shows less side growth and forms quantum contact in a shorter period of time.

A unique advantage of using electrochemistry to tune the tunneling junction is that this process is fully reversible. A control program was created which can actively track the conductance across the transverse electrodes at the end of every period of the pulsatile deposition. If the conductance is above a threshold, the program will flip the polarity of the bias V_{dep} to switch from the deposition mode to dissolution mode such that Au is removed in controlled steps. FIG. 9D gives such an example where the transition happened at 342 s when the conductance reached above 1 conductance quantum G₀. More specifically, FIG. 9D depicts a record of the potential V_{dep} applied to the Ag/AgCl counter electrodes for controlled Au deposition (when V_{dep}>0) and dissolution (when V_{dep}<0), and the corresponding amplitude (in units of conductance quantum G₀=2²/h=77.5 μS) and phase of the AC conductance between the transverse electrodes recorded at 10.13 kHz. An automated control program monitors the conductance during the deposition. When the conductance reaches a threshold above 1 G₀, the program switches the polarity of V_{dep} (at 342 sec) to remove Au from the electrode with negative pulses.

G₀ was used as the typical threshold as it can serve as the calibration of zero distance between the electrodes as they make first atomic contact. Such process can be repeated with high reproducibility to open and close the tunneling gap and generate a stable junction as defined by the final tunneling conductance (FIG. 9E). Specifically, FIG. 9E depicts conductance between transverse electrodes showing controlled reversible closing and opening of the gap for multiple times.

It is herein noted that as the feedback control signal, the conductance between the transverse electrodes may be tracked using an AC signal ranging from 1 Hz to ˜10 kHz with a lock-in amplifier. For example, when higher frequency is used, the conductance may start showing clear changes at longer distance on the order of tens of nm due to the capacitive component, which gives wider range of control in distance. This is also demonstrated in the recorded phase of the AC conductance in FIG. 9D when 10.13 KHz reference signal was used, which showed an early transition in phase from more capacitive to more resistive before significant changes in the amplitude happened later. Nevertheless, in this disclosure, dimensions are focused on that should best fit the diameter of the DNA molecules, therefore, low frequency AC signals (5 Hz) was used to monitor and control the junction's size which is most sensitive in the tunneling region. For devices used in DNA translocation experiments, the disclosed control program stabilizes the junction conductance to ˜1 nS, corresponding to a gap distance between 1-2 nm.

As alluded to above with regard to FIGS. 9A-10B, construction of nanopore devices of the present disclosure, via the use of feedback-controlled electrodeposition of metal onto a pair of initial electrodes sandwiched between two dielectric passivation layers, can be used to shrink an initial gap/cavity such that a nanopore device and a tunneling junction are formed simultaneously and in a self-aligned manner. It is herein recognized that in some examples, due to quick depletion of metal ions in the confined space, the size and sharpness of tunneling electrodes can degrade (e.g., become blunt) over some period of time. It is herein recognized that during the feedback-controlled electrodeposition of metal onto the pair of initial electrodes, metal deposition can tend to happen more on the edges of the electrodes which have better access to the metal ions than the tip region where depletion happens much quicker. In addition, due to the preferential deposition of metal on the edges of the electrodes, overall deposition time can be quite long before the tunneling junction reaches desired size (e.g., on the order of 1 to several nanometers or thereabouts).

Accordingly, herein are disclosed several approaches that improve various aspects of the nanopore device construction procedure. Specifically, herein is disclosed methodology that may improve at least 1) deposition speed for the final device, 2) tip sharpness corresponding to the electrodes comprising the tunneling junction, and 3) stability of the finally formed junction.

In one example, fast pulsed electrodeposition was compared to slow pulse or continuous deposition methodology. In a typical experiment, it was found that the optimal deposition time is <50 ms during which the electrodes are held at a reducing potential to allow metal ions to be reduced and deposited onto the electrode, followed by a 500 ms to about 2 second (2000 ms) rest time. During the rest time, the electrodes are held at a potential where no Faradaic current is present to allow a diffusion process to compensate the consumed metal ions near the tips of the electrodes. It has been found with the current setup that 2 ms-5 ms (e.g., 2 ms, 3 ms, 4 ms, 5 ms) can be an optimal deposition time. However, shorter deposition times may also be used without departing from the scope of this disclosure. For example, where equipment bandwidth allows, shorter deposition times including deposition times between 10 μs and 1 ms may be used. More specifically, deposition times may be between 10-500 μs, or 500 μs-1 s, or 10-450 μs, or 10-400 μs, or 10-350 μs, or 10-300 μs, or 10-250 μs, or 10-200 μs, or 10-150 μs, or 10-100 μs, or 10-90 μs, or 10-80 μs, or 10-70 μs, or 10-60 μs, or 10-50 μs, or 10-40 μs, or 10-30 μs, or 10-20 μs. In some examples, deposition times could be even lower, such as below 10 μs, for example below 1 μs. It is herein recognized that shorter deposition times may in turn enable shorter rest times, thereby improving (e.g., reducing) an overall timeframe for construction of the device.

In another example, it is herein disclosed that a small bias of about 50-100 mV between the two chambers (e.g., cis and trans) can encourage electrophoresis and electroosmotic flow between the chambers without affecting the Faraday process at the electrodes. This can have the effect of forcing a faster compensation of metal ions into the deposition region, which may enable shorter rest times and thus shorter device construction times, similar to that discussed above.

In another example, it is herein recognized that an asymmetric setup may lead to asymmetric deposition, which may in turn result in a sharper tip corresponding to each of the tunneling electrodes. Turning to FIG. 10C, depicted is an example illustration showing that when metal ions (depicted as spheres) are allowed to uniformly diffuse to the electrodes, the overall radius of the electrodes will increase. Specifically, with regard to FIG. 10C, dashed lines indicate shape of the electrodes pre-uniform deposition process, whereas the arrows indicate how the electrodes increase in size uniformly as a result of the uniform deposition process. Alternatively, turning to FIG. 10D, if metal ions (depicted as spheres) are provided in just one of the two chambers, asymmetric deposition may enable a sharper electrode shape near the tip, as indicated at the bottom-half of FIG. 10D.

It is further recognized herein that a newly prepared tunneling junction that has reached a desired distance as indicated by the conductance between the electrodes may be unstable over a period of time. A solution to this may be to utilize the reversibility of the electrochemical process to repeatedly construct the gap any number of times. Namely, a method may include expanding the junction by metal oxidation (by switching the polarity of potential applied at the metal electrodes) so that freshly deposited metal is removed, followed by a redeposition step to reach the desired gap size again. The purpose of this oxidation and reducing cycle may be to fill in the most active sites on the electrodes (e.g., sites that are most likely to deform/reshape under ambient conditions over time), and remove atoms that are most active and mobile in the reverse process. By repeating this process any number of times (e.g., 10-1000×), surface sites that are most likely to cause reshaping that leads to unstable gap geometry may be sacrificed, resulting in a “retarded” surface and hence a stable gap.

### Example 5

DNA Translocation Detection from Both Ionic and Tunneling Currents

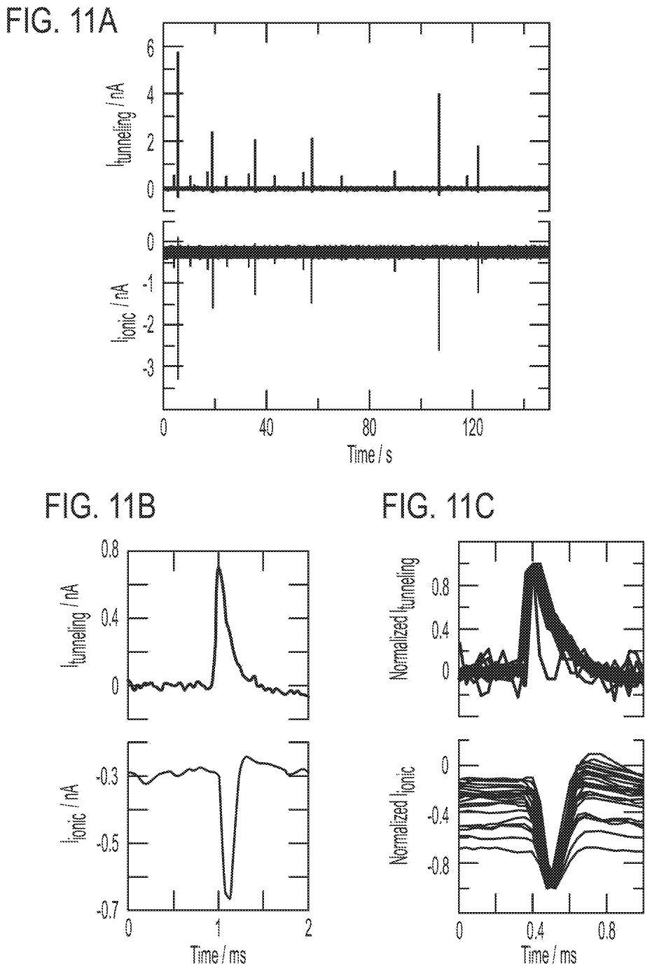

When the nanopore and tunneling junctions are prepared, the chip is flushed by PB, and the surface of the electrodes are modified with poly(ethylene glycol) methylether thiol (PEG thiol, Sigma-Aldrich) overnight to minimize the interaction between the DNA molecule and the Au surface. Lambda-DNA solution of 0.8 nM is prepared from commercial products (Sigma-Aldrich) with filtered PB and introduced into the cis-chamber, while the trans-chamber is filled only with PB. Ag/AgCl electrodes with salt bridge are used to apply a −50 mV bias for the cis chamber and 0 V for the trans-chamber. Within a couple of minutes after the lamda-DNA reaches the cis-chamber, the ionic current start to show characteristic spikes corresponding to the translocation events of DNA moving from cis- to trans-chamber. The polarity of the signals is a negative spike showing an increase in current magnitude, which is consistent with the low concentration of electrolyte that was used. For all the ionic events, rather strong current spikes with consistent polarity are observed from the transverse electrodes (FIG. 11A). Specifically, FIGS. 11A-11C depict DNA translocation events detected simultaneously from both ionic current and from the current between transverse electrodes. FIG. 11A illustrates correlated current spikes with consistent polarities recorded as 0.8 nM lambda-DNA is introduced to the cis-chamber and driven to the trans-chamber by a −50 mV bias. FIG. 11B illustrates a typical event taken from the record, and FIG. 11C shows all events normalized by its magnitude and overlapped by its peak time.

It is herein noted that: (1) If the tunneling junction has a conductance <0.1 nS, it was not possible to record any events from either currents; (2) The polarity of the “tunneling” current appears to follow a fixed relation with the polarity of the ionic current. Namely, when the negative ionic current spike suggests a “forward” event occur (DNA molecule translocate from cis- to trans-chamber) and the “tunneling” current showed positive current spike, the “backward” event (DNA molecule translocate from trans-chamber back to cis-chamber) always gives a positive ionic current spike with a corresponding negative “tunneling” current spike; (3) The shape and timing of the spikes are not the same between the ionic events and the tunneling events. Namely, the ionic spikes typically demonstrate a slight biphasic tail, while the “tunneling” spikes consistently demonstrate a slightly wider peak width with a longer tail and an offset in the peak time (refer to FIG. 11B and FIG. 11C); (4) The magnitude of the “tunneling” spikes is surprisingly high, and oddly, did not show clear dependency on the bias applied between the transverse electrodes. Disclosed herein, 0-30 mV DC as well as 0-30 mV AC bias of different frequencies was used, and the amplitude of these huge spikes did not seem to alter. This strongly suggest that the detected signals from the transverse electrodes may have an origin in the transient movement of surface charges between the electrodes rather than in a tunneling process across the molecule. In other words, it may be that the large “tunneling” signal comes from the highly charged DNA molecule making contact with one electrode and then moving across the boundary of the electric double layers to the opposite electrode, as it maneuvers through the nanopore channel. The fast transition time and the net displacement of charges may cause the dominant transient current. Here for convenience, these events are referred to as “tunneling” events.

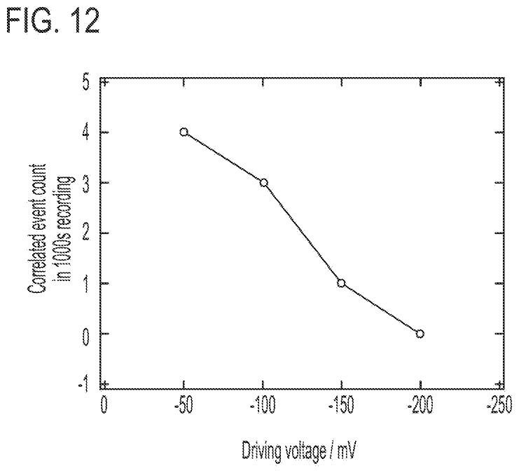

In addition, with the DNA concentration fixed, the event density depended on the driving bias between chambers. Briefly, when the driving bias is more negative than −200 mV in the cis-chamber, translocation events stopped to show up, and, surprisingly, the density of events increased as the driving bias was reduced (FIG. 12). Specifically, FIG. 12 illustrates detection of DNA translocation in tunneling and ionic currents under different driving bias and gap bias. The number of correlated events in 1000 s with a fixed gap bias (AC 10 mV 5 Hz+10 mV DC) and a various driving voltage is shown. The density of correlated events decreases when the driving bias increases from −50 mV to −200 mV. Without being bound to a theory, this observation is suggestive that due to the geometry and surface charge of our nanofluidic channels and electrolyte used, the electrodynamic forces, electroosmotic forces and the entropic forces may have impacted the translocation motion in different ways and what is seen here is a result of such combination.

It is herein recognized that it may be possible to take advantage of the fact that −200 mV driving bias can bring DNA molecules into the nanofluidic channel on the cis-side without passing to the trans-side under this condition. Specifically, a −200 mV driving bias was first applied for ˜50 minutes, during which time no translocation events were observed. The driving bias was then switched to ˜0 V, resulting in immediate observation of long bursts of events both in the “forward” (from cis- to trans-chamber) and the “backward” directions with an event density more than ten times higher than typically observed for the same concentration of DNA solution. This may be due to the accumulation of DNA molecules on the cis-side under the high driving bias. The high concentration gradient may cause the DNA molecule to pass through the nanopore when the high driving bias is removed. In addition, the electroosmotic force due to residue potential differences between the reference electrodes could drive the DNA molecules that have passed to the trans-side back to the cis-side. This can provide a potential strategy to enrich DNA molecules and quickly generate a large volume of data for low-copy number detections.

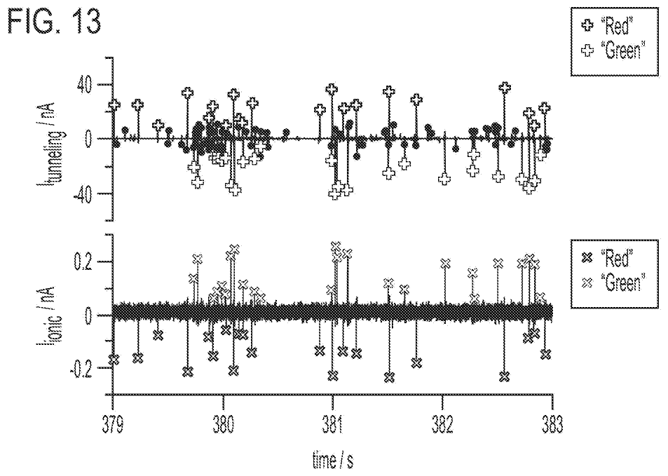

A section of the bi-directional signals is shown in FIG. 13. Events are defined in the ionic current and “tunneling” current that are close in time (within twice of their peak width) as “correlated” events. These event pairs are marked in red crosses and green crosses for “forward” and “backward” events, respectively, based on the polarity of the ionic current spike. The polarities of the correlated events follows strictly the same pattern as shown previously above. Significantly, >93% ionic events have correlated “tunneling” events, however, <35% “tunneling” events have correlated ionic events. This is in sharp contrast to the data obtained under stronger driving bias. The >65% “tunneling” events that do not have correlated ionic event are labeled with black dots in FIG. 13.

### Example 6

### Characteristics of Correlated and Uncorrelated Events

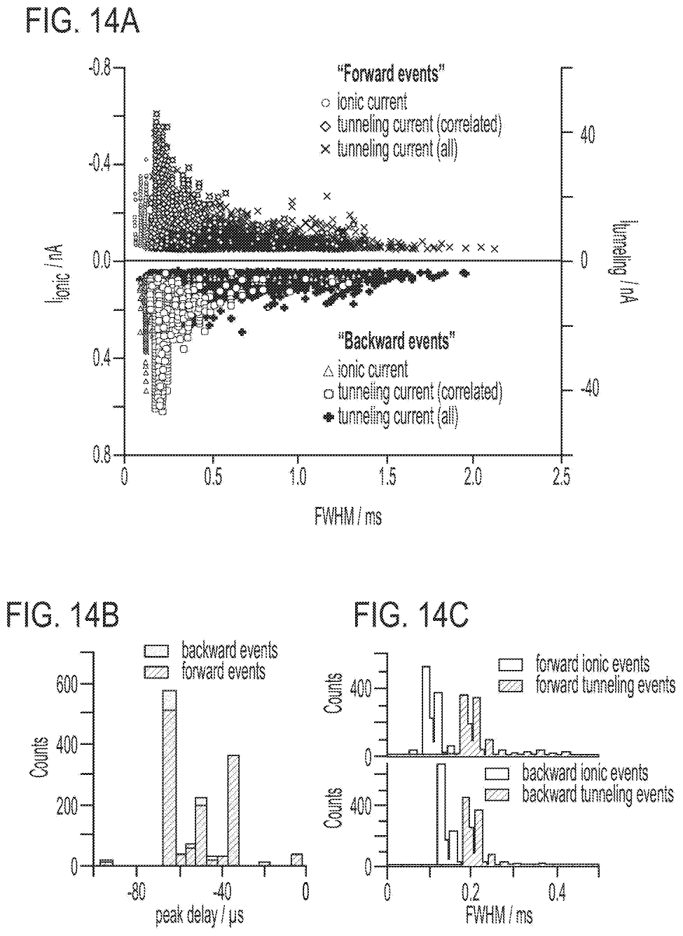

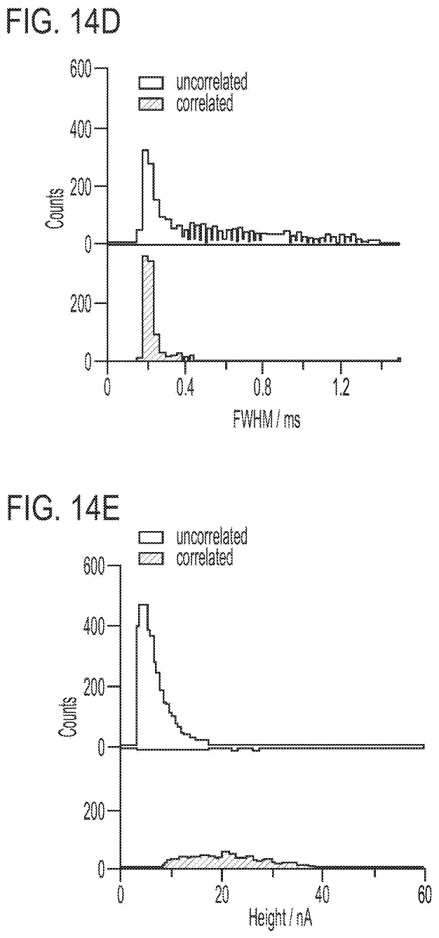

A detailed analysis of the bi-directional events reveals several important patterns. Briefly, FIGS. 14A-14E illustrate characteristics of the signals in forward and backward translocation events. FIG. 14A depicts a summary of distributions in peak height and full-width-at-half-maximum (FWHM) of the ionic and “tunneling” current signals. FIG. 14B depicts the offset of peak time of the “tunneling” signals vs the ionic signals. FIG. 14C Depicts a comparison of FWHM between correlated ionic and “tunneling” signals. FIG. 14D shows a comparison of FWHM for “tunneling” events that have correlated ionic events and those without. FIG. 14E depicts a comparison of peak height of “tunneling” events that have correlated ionic events and those without.

As shown in FIG. 14A, the “forward” and “backward” events are almost symmetrical in their count numbers and distributions in peak height and peak width, except for a subtle difference in correlated events. This is consistent with the experiment setup where the local concentration gradient and a weak electroosmotic force are believed to be the driving forces for such events. Also, for correlated event pairs, the “tunneling” events demonstrated interestingly an evenly spaced pattern of leading time of 35 μs, 50 μs and 65 μs than the ionic events for both directions (FIG. 14B). This suggested that the time difference was not due to a systematic offset introduced by filters or delays in electronics. This pattern may be related to the interplay between the nanoscopic geometry of the tunneling junction in the translocation path and the length/shape of molecules. Furthermore, again, for correlated events, the “tunneling” signals showed consistently wider peak width of ˜0.2 ms for both “forward” and “backward” directions than their ionic counterparts, while the ionic events showed a slightly faster translocation speed in the “forward” direction, hence smaller peak width, than in the “backward” direction (FIG. 14C). Since the DNA molecules in the cis-chamber were first enriched before allowing translocation by turning off the driving bias, the concentration gradient may have favored “forward” events to cause such slight difference in translocation time.

In addition, the high percentage (>93%) of the ionic events showing correlated “tunneling” signals is suggestive that the disclosed strategy of preparing final devices has been effective in getting the dimension and position of the tunneling junction nicely aligned with the nanopore structure, such that almost all molecules that pass through the nanopore will demonstrate interaction with the transverse electrodes to generate a signal (the “correlated” tunneling events). On the other hand, it was also noticed that close to ⅔ of the tunneling events do not have corresponding ionic signals (the “uncorrelated” tunneling events). FIGS. 14D-14E compares just these correlated and uncorrelated tunneling events in terms of their peak width and peak height. Interestingly, it can be seen that the correlated tunneling signals generally demonstrate a narrower distribution of small peak width (0.2-0.4 ms), meaning that such events happened consistently faster, and a wider distribution of peak height at significantly higher value (10-40 nA). In sharp contrast, the uncorrelated events showed a much broader distribution of peak width covering up to 7 times longer in time (0.2-1.4 ms), and a much narrower distribution of peak height with an overall lower current level (5-20 nA).

Without being bound to a theory, it is herein speculated that the uncorrelated “tunneling” events can be attributed to the DNA molecules randomly bumping into contacts with the transverse electrodes but not translocating. The longer lifetime may suggest stronger interactions, and the smaller signal a longer section bridging the electrodes. These events could be further harnessed to explore characterizing molecular conductance based on specific binding interactions, in some examples.

The present disclosure can be embodied in-part in the form of computer-implemented processes and apparatuses for practicing those processes. The present disclosure can also be embodied in-part in the form of computer program code containing instructions embodied in tangible media or computer readable storage medium, wherein, when the computer program code is loaded into, and executed by, an electronic device such as a computer, micro-processor or logic circuit, the device becomes an apparatus for practicing the present disclosure.

The present disclosure can also be embodied in-part in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the present disclosure. When implemented in a general-purpose microprocessor, the computer program code segments configure the microprocessor to create specific logic circuits.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope. Those with skill in the art will readily appreciate that embodiments may be implemented in a very wide variety of ways. This application is intended to cover any adaptations or variations of the embodiments discussed herein. Therefore, it is manifestly intended that embodiments be limited only by the claims and the equivalents thereof.

I claim:

1. A device, systems, methods of making and uses thereof, such as for delivering and linking molecules between tunable metal nanogaps and measuring electrical and optical properties allowing for single molecule detection, as substantially disclosed and described in the specification and figures herein.

2. An electronic device, comprising:
a cis-fluidic channel/chamber and a trans-fluidic channel/chamber fabricated on a planar substrate;
a nanogap configured in between and connecting the cis-fluidic and trans-fluidic channels/chambers;
a first electrode and a second electrode sealed inside the channel, wherein the first and second electrodes being electrochemically deposited with one or more metal materials within the channel and under feed-back control, thereby forming an electronic device with a single path for a molecule to travel from the cis-fluidic channel/chamber to the trans-fluidic channel/chamber and the distance between the first and second electrodes being between about 1-100 nm to form the nanogap which is self-aligned and has a narrowest bottleneck in the path between the cis-fluidic and trans-fluidic channels/chambers.

3. The device of claim 2, wherein the planar substrate is a transparent substrate.

4. The device of claim 3, wherein the transparent substrate is glass or quartz.

5. The device of claim 2, wherein the planar substrate is a non-transparent substrate.

6. The device of claim 5, wherein the non-transparent substrate is silicon coated with a layer of oxide.

7. The device of any one of claims 2-6, wherein the first electrode and second electrode are formed of gold, palladium, platinum or combinations thereof.

8. The device of any one of claims 2-7, wherein the cavity in which the first electrode and second electrode are sealed is formed by one or more dielectric layers.

9. The device of claim 8, wherein the one or more dielectric layers is HfO2, SiO2 or any combination thereof.

10. The device of any one of claims 2-9, wherein the one or more metal materials are Ni, Co, Ni alloy, Co alloy, gold, palladium, platinum, iridium or their alloys or combinations thereof; and
wherein the first and second electrodes being electrochemically deposited with one or more metal materials within the channel and under feed-back control further comprises a pulsed electrochemical deposition operation with a pulse width of 50 ms or less and a rest period of between about 500 ms and 2 seconds between pulses.

11. The device of any one of claims 2-10, wherein the molecule is DNA.

12. A method to measure conductance and/or optical properties from single molecules, comprising:
detecting with a device of any one of claims 2-11 of an individual mounting and/or translocation event of single molecules by a correlated ionic current between channels/chambers and tunneling current between the first and second electrodes through the nanogap; and
performing electrical and/or optical characterization.

13. The method of claim 12, comprising wherein performing optical characterization include performing Raman spectroscopy, such as by performing tip-enhanced Raman spectrum through the transparent substrate to understand dynamic structure of single molecules.

14. A method of making a device for delivering and/or linking molecules between tunable metal nanogaps and measuring electrical and/or optical properties allowing for single molecule detection, comprising:
depositing one or more sacrificial layers on a planar substrate to define a guiding channel leading to a tunneling junction and height of a confined space for allowing electrochemical deposition;
positioning a pair of electrodes with spacing around 500 nm and 1 μm on top of a center region of the one or more sacrificial layers;
depositing a dielectric passivation layer on the pair of electrodes to seal the pair of electrodes within the one or more sacrificial layers;
depositing a top polymer of dielectric layer patterned to construct the shape of channels on top of the dielectric passivation layer to both protect the pair of electrodes underneath and serve as a mask;
exposing the one or more sacrificial layers below an open window area in the polymer or di-electric top mask by a reactive ion etching process;
attaching a top cover to seal the channels;
chemically etching one or more sacrificial layers by filling the channels with etchants for construct of the chambers/channels that lead to the pair of electrodes; and
depositing an additional metal layer onto each of the electrodes by electrochemical deposition, thereby forming the device for delivering and/or linking molecules between tunable metal nanogaps and measuring electrical and/or optical properties allowing for single molecule detection.

15. The method of making of claim 14, wherein the planar substrate is a transparent substrate.

16. The method of making of claim 15, wherein the transparent substrate is glass or quartz.

17. The method of making of claim 14, wherein the planar substrate is a non-transparent substrate.

18. The method of making of claim 17, wherein the non-transparent substrate is silicon coated with a layer of oxide.

19. The method of making any one of claims 14 to 18, wherein the pair of electrodes are formed of gold, palladium, platinum or combinations thereof.

20. The method of making of any one of claims 14 to 19, wherein the dielectric passivation layer on the pair of electrodes to seal the pair of electrodes within the one or more sacrificial layers is HfO2, SiO2 or any combination thereof.

21. The method of making any one of claims 14 to 20, wherein the additional metal is Ni, Co, Ni alloy, Co alloy, gold, palladium, platinum, iridium or their alloys or combinations thereof.

22. The method of making any one of claims 14 to 21, wherein the top polymer layer patterned to construct the shape of channels on top of the dielectric passivation layer to both protect the pair of electrodes underneath and serve as a mask is SU-8.

23. The method of making of any one of claims 14 to 21, wherein the top dielectric layer patterned to construct the shape of channels on top of the dielectric passivation layer to both protect the pair of electrodes underneath and serve as a mask is SiO₂.

24. The method of making of any one of claims 14 to 23, wherein the method produces electrodes that are 5-200 nm thick in a planar configuration.

25. The method of any one of claims 14 to 24, wherein single molecule detection is detection of single DNA molecule.

26. The method of any one of claims 14-25, wherein depositing the additional metal layer onto each of the electrodes by electrochemical deposition is via a pulsed electrochemical deposition operation comprising a pulse width of 50 ms or less and a rest period of between about 500 ms and 2 seconds between pulses.

27. A method of making a nanopore device that includes a nanopore and a tunneling junction, comprising:
depositing a first sacrificial layer defining a final cavity for electrochemical deposition and depositing a second outer sacrificial layer defining a final nanofluidic space connecting the nanopore to cis- and trans-chambers onto a substrate layer;
positioning a pair of electrodes with a spacing of about 500 nm to 1 μm on top of the first sacrificial layer;
depositing a passivation layer on top of the pair of electrodes, the first sacrificial layer, the second sacrificial layer and the planar substrate to seal the pair of electrodes and the first and second sacrificial layers;
conducting a dry etching process to remove one or more sections of the passivation layer to produce access windows to the second sacrificial layer;
attaching a top cover atop the passivation layer remaining following the dry etching process;
chemically etching the first and second sacrificial layers to construct the final cavity and the final nanofluidic space; and
narrowing the spacing between the pair of electrodes by a process of controlled electrodeposition of a metal onto the pair of electrodes to form the nanopore and the tunneling junction.

28. The method of claim 27, wherein the first sacrificial layer is comprised of Cr and is between 10-20 nm in thickness.

29. The method of claim 27, wherein the second sacrificial layer is comprised of Al and is about 200 nm in thickness.

30. The method of claim 27, wherein the top cover is comprised of PDMS.

31. The method of claim 27, wherein the process of controlled electrodeposition further comprises:
conducting a pulsed electrochemical deposition operation comprising a pulse width of 50 ms or less and a rest period of between about 500 ms and 2 seconds between pulses.

32. The method of claim 31, wherein the pulse width is between 1 ms and 5 ms.

33. The method of claim 31, wherein the pulse width is between 1 μs and 500 μs.

34. The method of claim 27, wherein the pair of electrodes are comprised of gold, palladium, platinum or combinations thereof.

35. The method of claim 27, wherein the metal used to narrow the space between the pair of electrodes is Ni, Co, Ni alloy, Co alloy, gold, palladium, platinum, iridium or their alloys, or combinations thereof.

36. The method of claim 27, wherein narrowing the spacing between the pair of electrodes by the process of controlled electrodeposition further comprises:
establishing a bias of about 50-100 mV between the cis- and trans-chambers.

37. The method of claim 27, wherein narrowing the spacing between the pair of electrodes by the process of controlled electrodeposition further comprises:
providing the metal in both the cis- and trans-chambers.

38. The method of claim 27, wherein narrowing the spacing between the pair of electrodes by the process of controlled electrodeposition further comprises:
providing the metal in just one of the cis- and trans-chambers.

39. The method of claim 27, wherein narrowing the spacing between the pair of electrodes by the process of controlled electrodeposition further comprises:
repeatedly narrowing and then expanding the spacing between the pair of electrodes any number of time via repetitive reversing of a polarity of the pair of electrodes.

40. The method of claim 27, wherein narrowing the spacing between the pair of electrodes by the process of controlled electrodeposition is used to create a final spacing between the pair of electrodes of 1 nm to 100 nm.

41. The method of claim 40, wherein the final spacing is 1 nm to 20 nm.

42. The method of claim 40, wherein the final spacing is 1-2 nm.

43. The method of claim 27, wherein the passivation layer is comprised of one or more of HfO₂ and SU8.

44. A method of using the nanopore device of claim 27 to enrich analyte molecules in the cis-chamber prior to allowing translocation of the analyte molecules though the nanopore and tunneling junction, comprising:
applying a first driving bias for a first duration of time and then switching the driving bias to 0 mV.

45. The method of claim 44, wherein the first driving bias is about −200 mV.
